(19) United States
(12) Patent Application Publication
(10) Pub. No.: US 2011/0123192 A1
(43) Pub. Date: May 26, 2011

(54) Optical Under-Sampling And Reconstruction Of Sparse Multiband Signals

(75) Inventors: Amir Rosenthal, Haifa (IL); Moshe Horowitz, Haifa (IL); Michael Fleyer, Carmiel (IL); Yuval Shapira, Timrat (IL)

(73) Assignee: TECHNION RESEARCH AND DEVELOPMENT FOUNDATION LTD., Haifa (IL)

(21) Appl. No.: 12/864,739

(22) PCT Filed: Jan. 28, 2009
(86) PCT No.: PCT/IL09/00109

§ 371 Date: Feb. 8, 2011

Related U.S. Application Data
(60) Provisional application No. 61/024,002, filed on Jan. 28, 2008.

(51) Int. Cl. H04J 14/00

(52) U.S. Cl. 398/43

(57) ABSTRACT

A scheme for reconstructing multiband signals that occupy a small part of a given broad frequency range under the constraint of a small number of sampling channels. The multirate sampling scheme (MRS) entails gathering samples at several different rates whose sum is significantly lower than the Nyquist sampling rate. The number of channels does not depend on any characteristics of a signal. The reconstruction method may or may not rely on the synchronization between different sampling channels. The scheme can be implemented easily with optical sampling systems. The optical pulses required for the under-sampling are generated by a combination of an electrical comb generator and an electro-absorption optical modulator

### TECHNICAL FIELD

The present invention relates in general to reconstructing a signal from a sample, and in particular to reconstructing a multiband sparse signal from its sample.

### BACKGROUND ART

A multiband signal is one whose energy in the frequency domain is contained in the finite union of closed intervals. A sparse signal is a signal that occupies only a small portion of a given frequency region. In many applications such as nuclear magnetic resonance (NMR), magnetic resonance imaging (MRI), radars and communications systems, it is desirable to reconstruct a multiband sparse signal from its samples. When the signal bands are centered at frequencies that are high compared to their widths, it is not cost effective and often is not feasible to sample at the Nyquist rate F_{nyq}; the rate that for a real signal is equal to twice the maximum frequency of the given region in which the signal spectrum is located. It is therefore desirable to reconstruct the signal by undersampling; that is to say, from samples taken at rates significantly lower than the Nyquist rate. Sampling at any constant rate that is lower than the Nyquist rate results in downconversion of all signal bands to a low-frequency region called a baseband. This creates two problems in the reconstruction of the signal. The first is a loss of knowledge of the actual signal frequencies. The second is the possibility of aliasing, i.e., of the spectrum at different frequencies being downconverted to the same frequency in the baseband.

Optical systems are capable of very high performance undersampling [3]. They can handle signals whose carrier frequency can be very high, on the order of 40 GHz, and signals with a dynamic range as high as 70 dB. The size, weight, and power consumption of optical systems make them ideal for undersampling. The simultaneous sampling of a signal at different time offsets or at different rates can be performed efficiently by using techniques based on wavelength division multiplexing (WDM) that are used in optical communication systems.

There is a vast body of literature on reconstructing signals from undersampled data. Landau proved that, regardless of the sampling scheme, it is impossible to reconstruct a signal of spectral measure λ with samples taken at an average rate less than λ [4]. This rate λ is commonly referred to as the Landau rate. Much work has been done to develop schemes that can reconstruct signals at sampling rates close to the Landau rate. Most are a form of a periodic nonuniform sampling (PNS) scheme [5-11]. Such a scheme was introduced by Kohlenberg [5], who applied it to a single-band signal whose carrier frequency is known a priori. The PNS scheme was later extended to reconstruct multiband signals with carrier frequencies that are known a priori [6,10].

In a PNS scheme m low-rate cosets are chosen out of L cosets of samples obtained from time uniformly distributed samples taken at a rate F, where F is greater than or equal to the Nyquist rate F_{nyq} [6]. Consequently, the sampling rate of each sampling channel is L times lower than F, and the overall sampling rate is L/m times lower than F. The samples obtained from the sampling channels are offset by an integral multiple of a constant time increment, 1/F. This sampling scheme may resolve aliasing. In a PNS scheme the signal is reconstructed by solving a system of linear equations [6]. PNS schemes can often achieve perfect reconstructions from samples taken at a rate that approaches the Landau rate under the assumption that the carrier frequencies are known a priori. However, in order to attain a perfect reconstruction, the number of sampling channels must be sufficiently high such that the equations have a unique solution [6].

When the carrier frequencies of the signals are not known a priori, in a PNS scheme a perfect reconstruction requires the sampling rate to exceed twice the Landau rate [7,8]. In addition, in a PNS scheme the number of sampling channels must be sufficiently high [8]. Under these two conditions, a solution to the set of equations in a PNS scheme may be obtained assuming that the sampled signal is sparse [8]. When a PNS scheme is applied to an N-band real signal (N bands in the interval [0,F_{nyq}/2]), at least 4N channels are required for a perfect reconstruction [7,8]. A method for obtaining a perfect reconstruction has been demonstrated only with the number of channels equal to 8N [8]. Even when the requirement of perfect reconstruction is relaxed, the number of channels required to obtain an acceptably small error in the reconstructed signal may be prohibitively large. Furthermore, the implementation of the schemes to attain the minimum sampling rate relies heavily on the assumed values of the widths of the sample bands and on the number of bands of the signal [8]. In the case that the bands of the signal have different widths, a PNS scheme for obtaining the minimum sampling rate has not been demonstrated.

Other important drawbacks of PNS schemes stem from the fact that the systems of equations to be solved are poorly conditioned [9]. Thus, the schemes are sensitive to the bit number of analog-to-digital (A/D) conversion. They are also sensitive to any noise present in a signal and to the spectrum of the signal at any frequencies outside strictly defined bands. Moreover, the use of undersampling significantly increases the noise in each sampling channel, since the noise in the entire sampled spectrum is downconverted to low frequencies. Therefore, the dynamic range of the overall system is limited. The noise may be reduced by increasing the sampling rate in each channel. However, since the number of channels needed for a perfect reconstruction is determined only by the number of signal bands, the overall sampling rate dramatically increases. Another important drawback of a PNS scheme is the requirement of a very low time jitter between the samplings in the different channels.

### SUMMARY OF INVENTION

It is an object of the present invention to propose a scheme for reconstructing sparse multiband signals.

It is another object of the present invention to reconstruct signals accurately with a very high probability at an overall sampling rate that is significantly lower than the Nyquist rate under the constraint of a small number of channels.

It is a further object of the present invention to propose a scheme for reconstructing sparse multiband signals using asynchronous sampling channels.

It is yet another object of the present invention to propose a scheme for reconstructing sparse multiband signals using synchronous sampling channels.

The present invention relates to an optical system for undersampling sparse multi-band signals. Such signals are composed of several bandwidth limited signals. The carrier frequencies of the signals are not known a priori and can be located anywhere within a very broad frequency region (0-18 GHz). The system of the invention is based on under-sampling either asynchronously or synchronously the signals at a small number of different rates, for example, three. The under-sampling is performed by down-converting the entire signals spectrum to a low-frequency region called baseband. The baseband is then sampled using electronic analog-to-digital converters with a bandwidth that is significantly narrower than twice the maximum carrier frequency of the input signals. By separating the frequency down-conversion and the analog to digital conversion operations it becomes possible to use a single frequency resolution that is common to all of the sampling channels. This facilitates a robust reconstruction algorithm that is used to detect and reconstruct the phase and the amplitude of the signals.

In one aspect the present invention relates to a system for multirate sampling and reconstruction of sparse multiband signals, comprising:

(i) a plurality of optical pulse generators adapted for generating optical pulses at different rates;

(ii) an optical multiplexer adapted for adding said plurality of optical pulses;

(iii) a modulator for modulating the optical pulse trains coming out of the optical multiplexer by an electrical signal;

(iv) an optical demultiplexer adapted for separating the modulated optical pulse trains;

(v) a plurality of optical detectors adapted for detecting the separated modulated optical pulses; and

(vi) a plurality of analog-to-digital electronic converters for sampling the signal coming out of the plurality of said optical detectors.

In one embodiment of the present invention, each of the optical pulse generators comprises a continuous wave laser; an RF comb generator; and an electro-absorption modulator.

In another embodiment of the present invention, the modulator is a Mach-Zehnder modulator.

In a further embodiment of the present invention, an optical amplifier receives the added optical pulses coming out of the optical multiplexer, amplifies the optical pulses and then outputs the amplified pulses to the modulator.

In yet another embodiment of the present invention, the optical amplifier is an erbium doped fiber amplifier.

In yet a further embodiment of the present invention, the output of the optical detectors is then passed through low-pass filters.

In yet another embodiment of the present invention, the output of the low-pass filters is amplified by electrical amplifiers.

In yet a further embodiment of the present invention, the system comprises three optical pulse generators.

In yet another embodiment of the present invention, the plurality of optical pulse generators are synchronized in time.

In yet a further embodiment of the present invention, the plurality of optical pulse generators are not synchronized in time.

In yet another embodiment of the present invention, the optical carrier frequencies of each pulsed optical source is different, and the optical multiplexer and optical de-multiplexer are of add-drop type.

In another aspect, the present invention relates to a system for generating a train of narrow optical pulses, comprising:

(i) a constant wave laser;

(ii) an electro-absorbtion modulator; and

(iii) a radio-frequency (RF) pulse train generator, wherein the constant wave laser is modulated by RF pulses from the RF pulse train generator through the electro-absorbtion modulator.

In a further aspect, the present invention relates to a method for multirate sampling and reconstruction of sparse multiband signals, comprising the steps of:

(i) sampling the signals at n channels, each channel operating at a different frequency;

(ii) finding the supports of the signals in each channel;

(iii) up-converting the samples to all possible transmission bands according to the sampling rate in each channel;

(iv) finding all the possible up-converted support structures that are consistent with the supports of the sampled signals in each channel;

(v) finding amplitude consistent combinations;

(vi) finding large unaliased intervals of the sampled signals;

(vii) reconstructing the amplitude of the sampled signal; and

(viii) reconstructing the phase of the sampled signal.

In one embodiment of the present invention, n equals three.

In another embodiment of the present invention, the signal samples are synchronized in time.

In a further embodiment of the present invention, the signal samples are not synchronized in time.

In one embodiment of the present invention, the reconstruction method does not rely on synchronization between different sampling channels. This significantly reduces hardware requirements. The system also does not require an accurate calibration of the sampling channels. Because the entire frequency region of the signal is downconverted to baseband, aliasing may cause a deterioration in the down-converted spectrum. However, when the sum of the signals forms a sparse wave, a very high theoretical successful reconstruction percentage (>98%) can be obtained using the reconstruction algorithm of the invention when the sum of the bandwidths of the signals does not exceed about 800 MHz. The system of the invention can use standard optical components that are used in optical communication systems. The optical system is robust against changes in environmental conditions. It is a turn-key system that does not require any adjustments prior to the start of its operation. The weight, power consumption, dynamic range, and bandwidth of the optical system are significantly superior to those of electronic systems capable of meeting similar requirements. The performance of the reconstruction algorithm can be further enhanced by synchronizing the three sampling channels. With such a synchronization aliasing can often be resolved by solving a set of linear equations. The system bandwidth can be further increased by shortening the optical pulses by using an improved comb generator. The SFDR of the system can be further increased by adding optical filters, reducing the system loss, and by improving the reconstruction algorithm.

Typical undersampling schemes are periodic nonuniform sampling (PNS) schemes. In such schemes samples are taken from several channels at the same low rate. These schemes have many drawbacks. The present invention relates to a new scheme for reconstructing multiband signals under the constraint of a small number of sampling channels. The invention proposes a multi-rate sampling (MRS) scheme: a scheme in which each channel samples at a different rate. Sampling with the MRS scheme of the invention can overcome many of the difficulties inherent in PNS schemes and can effectively reconstruct signals from undersampled data. For a typical sparse multiband signal, the MRS scheme of the invention has the advantage over PNS schemes because in almost all cases, the signal spectrum is unaliased in at least one of the channels. This is in contrast to PNS schemes. With PNS schemes an alias in one channel is equivalent to an alias in all channels.

The MRS scheme of the invention typically uses a smaller number of sampling channels than do PNS schemes. In experiments described in Section 2 below demonstrating choosing to sample at a sampling rate higher than that used in PNS schemes to attain the theoretical minimum overall sampling rate required for a perfect reconstruction. The use of higher rates has an inherent advantage in that it increases the sampled SNR. The MRS scheme of the invention also does not require the solving of poorly conditioned linear equations that PNS schemes must solve. This eliminates one source of lack of robustness of PNS schemes. Our simulations indicate that MRS schemes, using a small number of sampling channels (three in our simulations) are robust both to different signal types and to relatively noisy signals.

The reconstruction scheme of the invention does not require the synchronization of different sampling channels. This significantly reduces the complexity of the sampling hardware. Moreover, asynchronous sampling does not require very low jitter between the sampling times at different channels as is required in PNS schemes. The reconstruction scheme of the invention resolves aliasing in almost all cases but not all. In rare cases, reconstruction of the originating signal fails owing to aliasing. One of the methods to resolve aliasing is to synchronize the sampling in all the channels. With such synchronization, aliasing can be resolved by inverting a matrix as is similarly done in PNS schemes. However, such an approach requires both much more complex hardware and a larger number of sampling channels that sample with a very low jitter. Moreover, in the case of signals that are aliased simultaneously in all channels, the noise in the reconstructed signal is expected to be much stronger than the noise in the original signal.

The present invention further relates to a synchronous multirate sampling scheme for accurately reconstructing sparse multiband signals using a small number of sampling channels whose total sampling rate is significantly lower than the Nyquist rate. This scheme of the invention is an alternative approach to a multi-coset sampling scheme when the number of sampling channel is limited. The scheme is especially effective when the sampling rate of each sampling channel is high. Sampling with high rates is also advantageous due to higher signal to noise ratio that is obtained in baseband.

Although the multi-coset sampling scheme can attain perfect reconstruction with much lower total sampling rates than required in SMRS, the number of sampling channels that is needed may be too large for practical implementation. The high number of sampling channels and the ability to select the time offset of each channel in multi-coset schemes enables to obtain a universal sampling matrix. With a universal sampling pattern the spark of the sampling matrix becomes equal to the number of sampling channels plus one.

The present invention provides a new reconstruction method that includes a reduction procedure and a block-sparsity modification of the pursuit algorithm. The reduction procedure can sometimes even lead to a full-column rank matrix which can be immediately inverted without applying any pursuit algorithm. We also use high frequency resolution. The simulation results show that this modifications makes it possible to recover many types of signals with a very high empirical reconstruction success rate.

The sampled data obtained using SMRS scheme can also be obtained using a multi-coset scheme but only one with a large number of channels that are offset by very small time increments. The recovery procedure based on a multi-coset sampling scheme (SBR4) [8] attains lower success rates with the same data collected by the multirate sampling scheme.

Sufficient conditions for perfect reconstruction in SMRS are provided based on the spark of the sampling matrix. The sufficient conditions do not take into account that the signal is blocked-sparse. Therefore, very high empirical reconstruction success rate is obtained when the sufficient conditions are not fulfilled.

### BRIEF DESCRIPTION OF DRAWINGS

FIG. 1 is a schematic description of an embodiment system used to under-sample electrical signals at three different sampling rates. Optical pulses are generated using three optical pulse generator (OPG) units consisting of a CW laser (CWL), a comb generator and an electro-absorption modulator (EA). By combining the three trains of optical pulses at different optical frequencies using a multiplexer (MUX) the input signal is sampled simultaneously at three different rates. After modulating the optical pulse trains by the electrical signal using modulator (MZ), the three modulated optical pulse trains are separated using an optical demultiplexer (DEMUX), detected using optical detectors, and sampled using a bandwidth limited analog-to-digital electronic converters (A/D). A PC computer is then used for the signal processing.

FIGS. 2A-2B are graphs showing electrical pulses at the output of the comb generator, as measured by a sampling oscilloscope (FIG. 2A) and an electrical spectrum analyzer (FIG. 2B). The repetition rate of the pulses equals 3.8 GHz.

FIGS. 3A-3B are graphs showing optical pulses at the output of the EA modulator, detected by an optical detector, and measured by a sampling oscilloscope (FIG. 3A) and an electrical spectrum analyzer (FIG. 3A). The repetition rate of the pulses equals 3.8 GHz.

FIG. 4 shows the spectrum of the electrical signal at the input of the MZ modulator as measured by an RF spectrum analyzer. The wave contains two chirped signals centered around 6.87 GHz and 9.13 GHz with a bandwidth of 150 MHz and 135 MHz, respectively.

FIGS. 5A-5C show the baseband spectrum after sampling using a pulse train with a repetition rate of 3.8 GHz in FIG. 5A, 3.9 GHz in FIG. 5B, and 4.0 GHz in FIG. 5C. Each spectrum is the amplitude of the Fourier transform of the corresponding sampled data.

FIG. 6 shows the amplitude of the reconstructed signal spectrum (solid line) compared to the spectrum of the input electrical signal that was measured using a spectrum analyzer (dashed line).

FIG. 7 is a graph illustrating the change in the instantaneous frequency

$$Δ f = \frac{1}{2 π} \frac{d φ}{d t} - {f}_{0}$$

of the reconstructed signal that is centered around a frequency f₀=6.87 GHz. φ(t) is the phase of the reconstructed signal in the time domain.

FIG. 8 is a graph illustrating Measurement of the spurious free dynamic range (SFDR) of the sampling channel obtained using a pulse train with a repetition rate of 3.9 GHz. The triangles show the measured input power of each of two CW RF signals at frequencies 6.197 GHz and 6.198 GHz. The squares show the corresponding measured power of the third order products at the output of the optical detector (see FIG. 1). The dashed line shows the average noise floor per Hz, as measured by the spectrum analyzer. The SFDR, shown in the graph, was equal to 94 dB-Hz^{2/3}.

FIGS. 9A-9C show an illustration of the spectrum of a sparse one-band real signal FIG. 9A and the spectrum of its samples that are obtained for the sampling rates F¹ FIGS. 9B and F² FIG. 9C. At f₀, the signal is unaliased at the sampling rate F¹ F but is aliased at the sampling rate F².

FIGS. 10A-10E show an illustration demonstrating how support consistency is checked. The input of the algorithm is the sampled signals whose spectra X¹(f) and X²(f) are shown FIGS. 9A and 9B, respectively; their respective indicator functions I¹(f) and I²(f) are shown in FIGS. 10A and 10B. FIG. 10C shows the indicator function I(f)=I¹(f)I²(f). In FIGS. 10D and 10E, we check whether the subset U={U₂}εP{U} is support consistent. FIGS. 10D and 10E show the indicator functions for the downconversion of U₂ at rates F¹ and F²: I¹_{U}_{₂}(f) and I²_{U}_{₂}(f), respectively. The dashed lines illustrate U₂, −U₂, and their downconversions. It is evident that the functions I¹(f) and I¹_{U}_{₂}(f) are not equal. Hence, U={U₂} is not a support-consistent combination.

FIGS. 11A-11B illustrate success percentage for the first set of simulations with F₀=1 GHz as a function of the Nyquist rate. In FIG. 11A, the percentage of a correct band detection is shown by the squares. The full reconstruction percentage is shown by circles. The open circles and squares represent the results obtained when the assumed maximum number of positive bands equals three. The dark circles and squares represent the cases in which the maximum assumed positive band number equals four. The full reconstruction percentages were the same for both choices of the maximum number of bands, and thus the open and dark circles are indistinguishable in this figure. FIG. 11B shows the band-detection percentage (solid curve) and reconstruction percentages (dashed curve) in the case that both the maximum number of originating and assumed positive bands equals four.

FIG. 12 is a graph illustrating the run time for the second set of simulations as a function of the Nyquist rate. The results in the case of four input positive bands with an assumed number of positive bands equal to four is shown by the solid curve. The results in the case of three input positive bands are shown with the dotted curve in the case of three assumed positive bands and with the dashed curve in the case of four assumed positive bands.

FIGS. 13A-13B illustrate success percentage for the first set of simulations as a function of the sum of the sampling rates divided by the Landau rate. As in FIG. 11, in FIG. 13A, the percentage of a correct band detection is shown by the squares. The full reconstruction percentage is shown by circles. The open circles and squares represent the results obtained when the assumed maximum number of positive bands equals three. The dark circles and squares represent the cases in which the maximum assumed positive band number equals four. FIG. 13B shows the band-detection percentage (solid curve) and reconstruction percentages (dashed curve) in the case where both the maximum number of originating and assumed positive bands equals four.

FIG. 14 illustrates the run time results for the first set of simulations as a function of the sum of the sampling rates divided by the Landau rate in the cases of signals with four and three positive bands. The results in the case of four input positive bands with an assumed number of positive bands equal to four is shown by the solid curve. The results in the case of three input positive bands is shown by the dotted curve in the case of three assumed positive bands and by the dashed curve in the case of four assumed positive bands.

FIG. 15 illustrates success percentage for the third set of simulations with F₀=1 GHz and F_{nyq}=20 GHz as a function of standard deviation a of the added noise. The figure shows the band-detection percentage (solid curve) and reconstruction percentages (dashed curve) in the case where both the maximum number of originating and assumed positive bands equals four.

FIG. 16 illustrates empirical success percentages for 4-bands complex signals calculated by using the SMRS reconstruction scheme (circles) and by using SBR4 in [8] (x) as a function of the spectral support (BW) for F_{Nyquist}=20 GHz and a total sampling rate Fₜₒₜₐₗ=3 GHz. The number of sampling channels is equal to 3 in the SMRS scheme and is equal to p=58 in the equivalent multi-coset sampling scheme.

FIG. 17 illustrates ill-posed cases mean percentage for 4-bands complex signals for different spectral supports (BW) with F_{Nyquist}=20 GHz and a total sampling rate Fₜₒₜₐₗ=3 GHz.

FIG. 18 illustrates mean run times for 4-bands complex signals for different spectral supports (BW) with F_{Nyquist}=20 GHz, total sampling rate Fₜₒₜₐₗ=3 GHz.

FIG. 19 illustrates empirical success percentages for equal 4-bands real signals calculated by using the SMRS reconstruction scheme (circles) and by using SBR4 in [8] (x) as a function of the spectral support (BW) for F_{Nyquist}=40 GHz and a total sampling rate Fₜₒₜₐₗ=12 GHz. The number of sampling channels is equal to 3 in the SMRS scheme and is equal to p=58 in the equivalent multi-coset sampling scheme.

FIG. 20 illustrates ill-posed cases mean rate for 4-bands real signals for different spectral supports (BW) with F_{Nyquist}=40 GHz, total sampling rate Fₜₒₜₐₗ=12 GHz. The number of channels in the equivalent multi-coset sampling scheme is p=58.

FIG. 21 illustrates mean recovery times for equal 4-bands real signals for different spectral supports (total bandwidth) with F_{Nyquist}=40 GHz, total sampling rate Fₜₒₜₐₗ=12 GHz.

FIG. 22 illustrates Empirical success percentages for 4 bands of real signals noise that were contaminated with a noise with a standard deviation of σ=0.04 for different spectral supports of the signal (BW) with F_{Nyquist}=40 GHz, and a total sampling rate Fₜₒₜₐₗ=12 GHz.

### DESCRIPTION OF EMBODIMENTS

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The description is divided into three sections: Section 1 describes an embodiment of a hardware system for reconstructing sparse multiband signals; Section 2 describes multirate asynchronous sampling of sparse multiband signals; and Section 3 describes multirate synchronous sampling of sparse multiband signals.

### Section 1—Hardware System for Reconstructing Sparse Multiband Signals

Sections 2 and 3 below demonstrate theoretically a different theoretical scheme for reconstructing sparse multiband signals which we call multi-rate sampling (MRS). The scheme entails gathering samples at P different rates. The number P is small and does not depend on the characteristics of the signal. The approach is not intended to obtain the total minimum sampling rate. Rather, it is intended to reconstruct signals accurately with a very high probability at an overall sampling rate significantly lower than the assumed Nyquist rate under the constraint of a small number of sampling channels.

The reconstruction method in of Section 2 below does not rely on synchronization of different sampling channels. This significantly reduces hardware requirements. Moreover, unsynchronized sampling relaxes the stringent requirement in PNS schemes of a very small timing jitter in the sampling time of the channels. Simulations indicate that asynchronous multi-rate sampling reconstruction is robust both to different signal types and to relatively high noise. The algorithm was tested in order to reconstruct both the phase and the amplitude of 4 real signals that overlapped in time. The carrier frequencies of the signals were randomly chosen in the region 0-20 GHz and the amplitudes of the signals were chosen independently from a uniform distribution in the region 1-1.2. Each one of the four signals had a bandwidth of 200 MHz and hence the sum of the signal bandwidths was equal to 800 MHz. Therefore, about 4% of the available spectrum was exploited. In each simulation the signal was sampled using three sampling channels that operated at 3.8 GSamples/sec, 4.0 GSamples/sec, and 4.2 GSamples/sec. A very high reconstruction probability (>98%) of both the signals amplitudes and phases was obtained in the simulations. The reconstruction probability depends on the total bandwidth of the signals and to some extent on the maximum number of signals. The result does not depend on the spectrum of the signals and on their chirp. Therefore, bandwidth limited signals with a spectrum having an arbitrary phase and amplitude can be reconstructed with a very high probability.

The bandwidth of electronic systems is limited. Therefore, in electronic systems that are used to sample signals with a carrier frequency that can be located in a large frequency region, the spectrum is divided into small frequency bands. Each band is down-converted and sampled by a different electronic subsystem. As a result, the size, the weight and the complexity of such electronic systems limit their applications. Alternatively, the spectrum can be scanned in time. At a given time, only a small portion of the spectrum is down-converted and sampled. Such a technique maximizes the dynamic range of the system. However, it does not allow a continuous sampling of the entire spectrum.

The bandwidth of analog optical systems is extremely high in compared to that available in electronic systems. Therefore, optical systems are capable of very high performance undersampling [3]. The carrier frequency of the input signal can be very high on the order of 20 GHz and the dynamic range of the signals can be as high as 70 dB. The size, weight, and power consumption of optical systems make them ideal for under-sampling. The under-sampling operation is based on shifting the entire spectrum to a low frequency region called the baseband [3], [13]. The down-converted signal is then sampled using an electronic analog-to-digital (A/D) converter with a bandwidth that is significantly narrower than the carrier frequency of the signal. A previous work [3] has demonstrated the under-sampling and reconstruction of a single narrow-band signal. However, the system required a priori knowledge of the carrier frequency of the signal and this knowledge was used to determine the sampling rate.

Described below is an experimental demonstration of an optical system of the invention for sampling sparse signals with carrier frequencies that are unknown a priori and are located in a broadband frequency region of 0-18 GHz. The system entails undersampling the signals asynchronously at three different rates. The optical pulses required for under-sampling are generated by a combination of an electrical comb generator and an electro-absorption (EA) modulator. Such an optical pulsed source is simple, small, and consumes low power. Moreover, the source is robust to changes in environmental conditions. The combination of the comb generator and the EA modulator that are used instead of two electro-absorption modulators that were used in Ref. [3] results in an increase in the output power of the pulse train by about 10 dB. The simultaneous sampling at different rates is performed efficiently by using methods based on a wavelength-division multiplexing (WDM) technique that is used in optical communication systems. Such a technique avoids loss caused by splitting of the signal between the sampling channels. This technique also enables use of the same electro-optic modulator for modulating all the sampling channels. Consequently, the frequency dependence of the modulator response curve has the same effect on all sampling channels. We have demonstrated experimentally an accurate reconstruction of both the phase and the amplitude of two chirped signals, generated simultaneously, each with a bandwidth of about 150 MHz. The carrier frequencies of the signals were not known a priori but were assumed to be within a frequency region of 0-18 GHz. The reconstruction did not depend on the chirp, the spectrum amplitudes, and the carrier frequencies of the signals. The spurious free dynamic range of the system was 94 dB-Hz^{2/3}.

### I.A. System Description

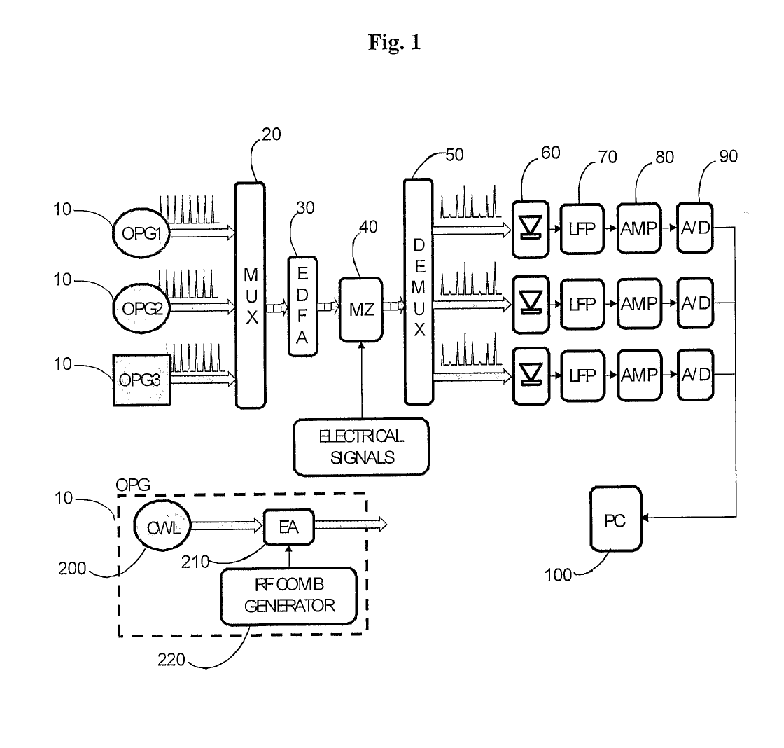

The experimental setup of the system is shown in FIG. 1. The spectrum of the signals was down-converted to a low frequency region, called baseband, by modulating the amplitude of a train of short optical pulses by the electrical signal [3]. Since the reconstruction algorithm requires sampling the signal at a small number—three different rates at this occurrence—the down-conversion of the signal was performed separately using three optical pulsed sources 10 that operate at different rates. The wavelengths of the optical pulsed sources 10 were chosen to be different: 1535.04 nm, 1536.61 nm, and 1544.53 nm. Hence, the three optical pulse sources 10 could be added by using an optical multiplexer (MUX) 20 and then be modulated by a single LiNbO3 modulator (MZ) 40. The specified electrical full-width-at-half-maximum (FWHM) bandwidth of the modulator 40 was greater than 30 GHz. The use of a single modulator reduces the sensitivity of the system to the frequency response function of the modulator 40 and simplifies the system design. Since the modulator 40 response is sensitive to its input polarization we used polarization maintaining (PM) fibers in all of the optical components that were connected before the input end of the modulator 40. In our experiments we lacked suitable optical multiplexer 20 with PM fibers. Instead, we used two PM couplers to multiplex the three optical signals. This added an additional loss of about 6 dB that can be avoided using a PM multiplexer 20. The optical losses due to the electro-absorption modulator 210, the electro-optical modulators 40, the multiplexer 20, and the de-multiplexer 50, were about 10 dB, 7 dB, 6 dB, and 1.5 dB, respectively. To compensate for these losses we used an erbium doped fiber amplifier (EDFA) 80 with a 30 dB gain. After passing through the modulator 40, the optical wave passed through a demultiplexer 50 that splits the optical signal into three pulse trains of different rates with an amplitude modulated according to the electrical signal. Each of the three modulated pulse trains was detected by an optical detector 60 connected to a transimpedance amplifier 80. The input optical power at the entrance of the detectors 60 was about [symbol] 4 dBm. The output of the transimpedance amplifiers 80 was then passed through low-pass filters 70 with a cutoff frequency of 2.2 GHz, amplified once again by electrical amplifiers 80 with a gain of 20 dB, and sampled by three electronic analog to digital (A/D) converters 90. Each of the A/D converters 90 sampled at a rate of 4 Gsamples/sec with 5 effective bits. In each sampling the number of sampled points in each channel was equal to 32,767. The output of the A/D converters 90 was directed to a personal computer (PC) 100 for processing.

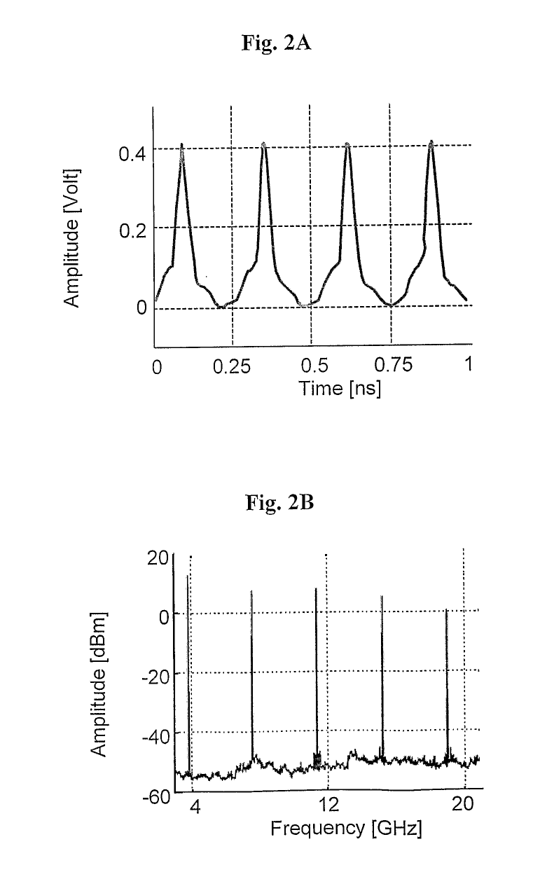

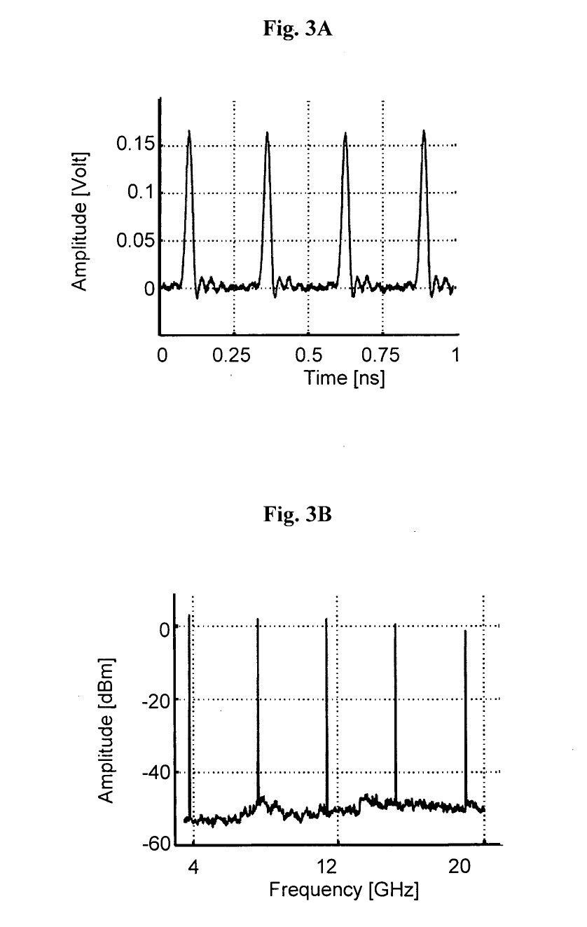

Each pulsed source 10 was implemented by a combination of an EA modulator 210 and a comb generator 220. The comb generator 220 is based on using a step-recovery diode (SRD) and is used to generate short electrical pulses from a sinusoidal electrical wave. FIG. 2 shows the electrical pulse train at the output of the comb generator 220. The train is measured by a sampling oscilloscope and by an RF spectrum analyzer. The measurement shows the existence of strong ripples between the pulses. Moreover, the difference between the harmonics at 3.8 GHz and 19 GHz is 12.3 dB. In Ref. [3] it has been shown that the bandwidth of the system is limited by the bandwidth of the RF spectrum of the optical pulses. Consequently, the pulse train at the output of the comb generator 220 cannot meet the requirement of sampling signals whose carrier frequency may be as high as 18 GHz. To rectify this, we connected the output of the comb generator 220 to the electrical input port of an EA modulator 210 with an electrical bandwidth of more than 30 GHz. The optical input to the modulator 210 is a continuous wave (CW) laser 200 with a power of 11.5 dBm. The nonlinearity of the modulator 210 enabled shortening of the optical pulse duration as well as a reduction in the intensity of ripples between pulses. Such improvement in the pulses is essential for high performance and high bandwidth sampling. FIG. 3A shows the optical pulses at the output of the EA modulator 210 after conversion to an electric signal by an optical detector 60 and measured by an RF spectrum analyzer and a sampling oscilloscope. The pulse duration obtained at the output of the electro-absorption modulator 210 was about 26 ps. The specified bandwidth of the sampling oscilloscope with the detector 60 was greater than 50 GHz. The FWHM of the impulse response of our sampling oscilloscope and the detector 60 was less than 9 ps. The RF spectrum of the optical pulses, shown in FIG. 3B shows that the difference between the RF harmonics at 3.8 GHz and the harmonics at 19 GHz was only 4.3 dB. The average power of each pulse train was about −11 dBm. The repetition rate of the optical pulses can be controlled easily by choosing different frequencies of the sinusoidal waves at the input of the comb generators 220. For a given comb generator 220, the input electrical sinusoidal wave could be changed by up to about ±2.5% with respected to the specified frequency of the device. By choosing three comb generators 220 with different specified frequencies we could generate the three different pulse trains as required to the sampling. Using a comb generator 220 and an EA modulator 210 instead of two EA modulators 210 as were used in Ref. [3] enables a reduction in the loss in the pulsed source by about 10 dB. We note that the three optical pulse generators 10 in our system were uncorrelated in time.

### I.B. Principle of Operation

The under-sampling is performed in two steps. In the first step the entire signal spectrum is down-converted to a low frequency region called baseband by modulating the amplitude of an optical pulse train by the electrical signal. In the second step the down-converted optical signal is transformed into an electronic signal that is then sampled by a bandwidth-limited electronic A/D converter 90. The bandwidth of the electronic A/D converter 90 is significantly narrower than the maximum carrier frequency of the signals. The optical under-sampling is performed at three different rates. The repetition rate of the optical pulses in each of the sampling channels is chosen to be different and should be lower than the sampling rate of the A/D converters 90 to avoid additional aliasing. On the other hand, the sampling rate of each channel is chosen to be approximately equal to the maximum sampling rate allowed by cost and technology. Under-sampling at high rates has a fundamental advantage when applied to signals contaminated by noise. The spectrum evaluated at a baseband frequency f_{b} in a channel that samples at a rate F is the sum of the spectrum of the original signal at all frequencies f_{b}+mF that are located in the overall system operational bandwidth, where m is an integer. Thus, the larger the value of F, the fewer terms contribute to this sum. As a result, sampling at a higher rate lowers the noise contribution and hence increases the signal-to-noise ratio (SNR) in the baseband. Moreover, when the sampling rate of each channel is increased, our reconstruction method, described in Section 2 below, enables to decrease the number of sampling channels. The sampling rates that were used in our experiments were 3.8 GHz, 3.9 GHz, and 4 GHz.

We denote the input wave spectrum at the RF input of the modulator 40 by S(f). The signal is sampled using an optical pulse train with a temporal pulse shape p(t) and a repetition rate F. The current spectrum i(f) of the optical detector 60 is proportional to [3]

$$i ( f ) ∝ f {\sum }_{n = - ∞}^{∞} S ( f - nF ) P ( nF ) , \qquad ( 1 )$$

where P(f) is the Fourier transform of a single optical pulse p(t) and n is an integer number. The spectrum at the output of each sampling channel contains replicas of the original spectrum S(f) shifted by an integer multiple of the repetition rate F. The signal spectrum is therefore down-shifted to a baseband where it can be sampled using a conventional electronic A/D converter 90. Because the sampling rate of each sampling channel is different, the corresponding spectrum in the baseband of each channel is different.

A signal processing algorithm, such as described in Sections 2,3 below, utilizes the information from the three sampling channels to reconstruct the original signal. The algorithm can correctly reconstruct both the phase and the amplitude of the signals in almost all cases; even in the cases when aliasing deteriorates the spectrum in parts of the basebands. The algorithm is based on extracting a spectrum that minimizes the error between the three down-converted spectra of the reconstructed signal and the spectra measured in the three sampling channels. The signal can be reconstructed accurately when each of the frequencies of the signal spectrum is unaliased at least in one of the sampling channels. Our simulations indicate that the multi-rate sampling scheme is robust both to different signal types and to relatively high noise.

### I. C. Experimental Results

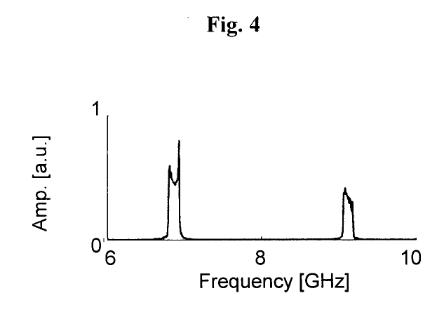

In our experiment we have demonstrated the sampling and the reconstruction of two chirped signals that are generated simultaneously. FIG. 4 shows the spectrum of the input RF wave as measured using an RF spectrum analyzer. The wave consisted of two chirped pulses with approximate square time profiles. The waves were generated using two independent fast voltage-controlled-oscillators (VCOs). The input voltage to the VCOs was linearly changed in time. However, because of the nonlinear dependence and the saturation of the VCO frequency as a function of the input control voltage, the chirp of the pulses did not change linearly in time in parts of the pulses. The first signal had a central frequency of 6.87 GHz and a bandwidth of 150 MHz. The second signal had a carrier frequency of 9.13 GHz and a bandwidth of 133 MHz. The average RF power of the superposed signals was approximately −14 dBm. The two signals were generated simultaneously and therefore we have studied the worst case scenario where the two signals almost completely overlap on time. The duration of the combined pulse was 1.35 μs. The repetition rate of the pulses was 2 kHz. We note that our simulation results indicate that the sampling system can be used to efficiently sample and reconstruct more than 4 chirped signals that are transmitted simultaneously. However, our source that generated the input signals could only generate simultaneously two chirped signals.

Mathematically, since the signals in our experiments are real functions each real signal is composed of two bands. One band with a spectrum S(f) is located in the positive frequency region (f>0), and another band with a spectrum S*(−f) is located in the negative frequency region. Therefore, mathematically, the signal spectrum in our system is composed of four frequency bands. We note that due to sampling each two of the four down-converted bands can overlap.

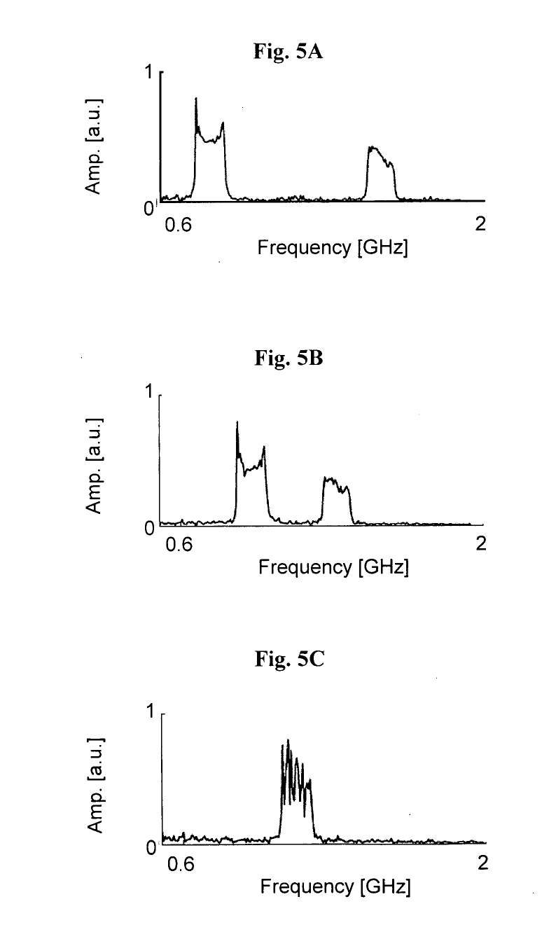

FIG. 5 shows the spectra at the output of the three sampling channels. The spectra were calculated by performing a discrete Fourier transform on the digital samples from the outputs of the three A/D converters 90. We note that after downconverting the signal using a pulse train with a rate of F the spectrum becomes periodic with a periodicity of F. Moreover, since the signal is real the down-converted spectrum obeys: i(f)=i*(−1). Therefore, when sampling at a rate of F, all the information about the down-converted signal is contained in the frequency region [0, F=2]. FIG. 5C shows that downconverting the signal at a rate of 4 GHz resulted in an interference in the spectrum at a frequency around 1.1 GHz due to aliasing effect. The aliasing was between the signal components around −6.87 GHz and 9.13 GHz.

Since our reconstruction method does not require synchronization of the sampling channels we did not have to adjust precisely the sampling rates. Moreover, our reconstruction method is highly robust since it does not require inverting ill-pose matrices, as in multicoset sampling schemes [9]. Therefore, a nonuniformity of about 10% between the signal amplitudes in different sampling channels did not significantly affect the reconstruction. Hence, we did not need to calibrate the amplitudes between the different channels after building the system. The runtime of our reconstruction algorithm using a standard personal computer (PC) 100 and the Matlab software was approximately 0.2 sec. The runtime can be significantly decreased by about three orders of magnitude using a software implemented in a digital-signal-processor (DSP).

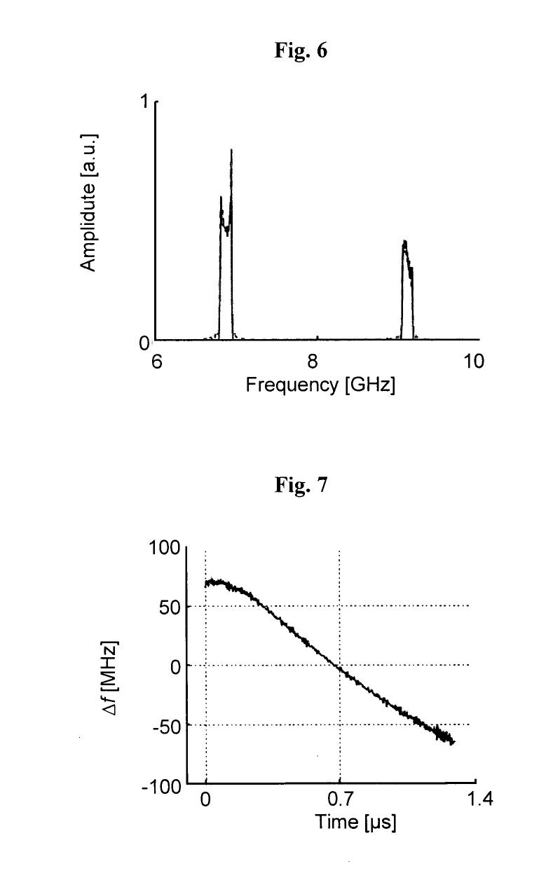

The algorithm for reconstructing the signal from the three sampled down-converted signals is described in detail in Section 2 below. FIG. 6 shows the amplitude of the reconstructed spectrum. For the comparison, the original spectrum as measured by the RF spectrum analyzer was added to the figure. FIG. 6 shows an excellent quantitative agreement between the reconstructed spectrum amplitude and the spectrum amplitude measured using the analog RF spectrum analyzer. An accurate reconstruction was obtained despite aliasing at the channel corresponding to a sampling rate of 4 GHz. Since the measurement of the RF spectrum analyzer is based on a slow frequency scan, measuring the whole spectrum requires many RF pulses. The system of the invention requires only a single RF pulse for measuring the entire spectrum and hence it can be used in real-time applications. Our system also allows a measurement of the phase of the input electrical signal. This important information can not be obtained using the RF spectrum analyzer. FIG. 7 shows the instantaneous frequency the time derivative dΦ(t)/dt of the time-domain phase of the reconstructed signal centered around the frequency f₀=6.87 GHz.

The sampling method of the invention enables to reconstruct sparse signals with an arbitrary spectrum. Section 2 shows that in order to obtain a very high reconstruction probability (>98%) the sum of the bandwidths of the signals in the system of the invention should not exceed about 800 MHz assuming that the maximum number of signals is four. We do not take into account any assumption on the signal chirp or on the spectrum amplitude. Indeed, FIG. 7 shows that the signal chirp that was measured does not have a simple time-dependent function. The chirp saturates at the beginning of pulse due to the response saturation of the VCOs used to generate the chirped RF pulses. The instantaneous frequency change during the pulse duration is equal to about 142 MHz. This result is in good quantitative agreement with the measured overall signal bandwidth of about 150 MHz. An accurate reconstruction of two signals was obtained in all of our experiments when the carrier frequencies of the two signals were chosen randomly from the frequency region 5-11 GHz. This frequency region was imposed by the bandwidth of our RF sources that were used to generate the signals, and not by the limitations of the sampling system. We note that in our reconstruction method we identify signals that are about 2 dB above the noise floor of our system. Since the reconstruction algorithm of the invention recognizes accurately the frequency bands of all the signals, the parts of the spectrum where the signal is not detected are set to zero. It is theoretically impossible to reconstruct the noise between the signals since the total sampling rate is lower than the Nyquist rate [8].

Since the carrier frequencies of the signals are not known a priori the reconstruction algorithm has to calculate first the frequency band of each signal. Then, the frequencies in each sampled spectrum that are unaliased are calculated. The reconstruction is performed according to all the sampled data that is not aliased. In case that the reconstruction algorithm identifies that a spectrum frequency is unaliased in more than one sampled spectrum, the reconstruction at this frequency is performed by averaging the corresponding data from all of the sampling channels that are unaliased. The averaging improves the SNR of the reconstruction. Moreover, the reconstruction algorithm does not require that a complete signal will be unaliased in one of the sampling channels. Different parts of the signal spectrum can be reconstructed from different sampling channels. Therefore, although most of the spectrum in the 4 GHz sampling channel is aliased, the reconstruction algorithm uses part of the data in this channel that is not aliased (about 20 MHz around a frequency of 1.2 GHz).

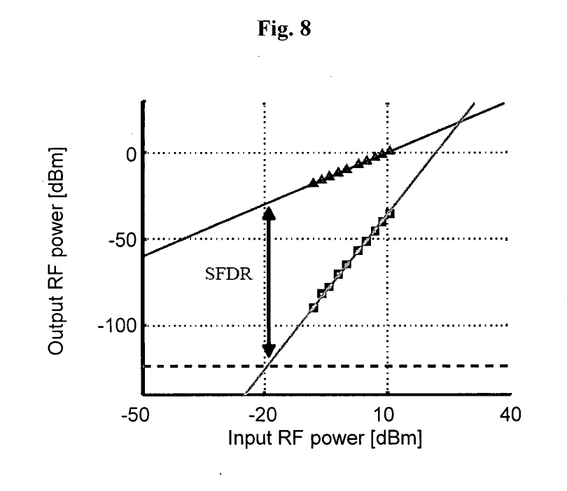

FIG. 8 summarizes the measurement of the spurious free dynamic range of the system. In this measurement the electro-optical modulator 210 was driven by two continuous wave (CW) 200 RF signals of the same power at adjacent frequencies of 6.197 GHz and 6.198 GHz. The power of the two CW electrical signals was gradually changed between −2 dBm and 10.5 dBm. For every value of the input power, the power of the third order products at frequencies 6.196 and 6.199 GHz was measured at the output of each of the three photo-detectors 60. The SFDR is defined as the difference in dB between the signals power and the power of the third order products, when the third order products are equal to the noise floor of the system. The result is normalized assuming that the spectral bandwidth of the system is equal to one Hz. The measurement of the noise power density was performed using the spectrum analyzer. The noise floor was measured 5 times for a resolution bandwidth that varied between 1 kHz to 100 kHz. In each measurement the noise floor was normalized to a spectral window of 1 Hz. The average noise floor that was obtained was equal to 138 dB/Hz (the red dashed line in FIG. 8). The obtained spurious free dynamic range of each of the channels due to third order distortion was about 94 dB-Hz^{2/3}. The bias voltage to the electro-optic modulator in our system was adjusted to minimize the second order distortion at a frequency 6.198+6.197=12.395 GHz. The SFDR2 that is caused by the second order distortion was equal to about 98 dB-Hz^{1/2}. Therefore, the spurious free dynamic range of our system was limited by the third order distortion.

The maximum spurious free dynamic range of a system based on under-sampling is lower than that of systems that sample at Nyquist rate. The reason is that the noise from the entire spectrum is down-converted to baseband. Since our sampling rate in each channel was around 4 GHz while the system bandwidth was about 20 GHz the noise power spectral density at baseband is expected to be about 2*5 times higher than that in the original signal. However, electronic sampling at Nyquist rate of 40 Gsamples/sec is currently unattainable. Moreover, it is expected that the huge bandwidth of a sampler with a sampling rate of 40 Gsamples/sec will result in a very high noise in the sampling. The SFDR of our commercial spectrum analyzer was about 108 dB-Hz2=3. However, the spectrum analyzer is based on a slow scan of the spectrum using a narrow-band filter. Due to the use of a narrow-band filter the noise in the measurement is very small. The SFDR obtained by our system is sufficient for most applications. Moreover, we believe that by using narrow optical filters, an optical multiplexer 20 instead of couplers, and an improved signal processing algorithm it is possible to reduce significantly the noise floor in the system.

The bandwidth of the system was measured by scanning the frequency of a CW RF source that was connected to the system input. The power of the down-converted signal was measured as a function of input signal frequency. The 3-dB bandwidth was about 17.8 GHz. The decrease in the transmission of our electro-optic modulator 210 between 100 MHz to 18 GHz was less than 1 dB. The FWHM bandwidth of our optical demultiplexer 50 was about 30 GHz and hence it should not limit significantly the system bandwidth. The system bandwidth that was measured is in agreement with the bandwidth of RF spectrum of the optical pulses −18 GHz, as indicated in FIG. 3B. Indeed, the theory shows that the maximum system bandwidth is limited by the bandwidth of the electrical spectrum of a single optical pulse [3]. Therefore, shortening the optical pulses will increase the system bandwidth.

### Section 2−Multirate Asynchronous Sampling of Sparse Multiband Signals

### 2.1 Introduction

The present invention further relates to a scheme for reconstructing sparse multiband signals. The scheme, which we call multirate sampling (MRS), entails gathering samples at P different rates. The number P is small (three in our simulations) and does not depend on any characteristics of a signal. The approach of the invention is not intended to obtain the minimum sampling rate. Rather, it is intended to reconstruct signals accurately with a very high probability at an overall sampling rate that is significantly lower than the Nyquist rate under the constraint of a small number of channels.

The success of the MRS scheme of the invention relies on the assumption that sampled signals are sparse. For a typical sparse signal, most of the sampled spectrum is unaliased in at least one of the P channels. This is in contrast to the situation that prevails with PNS schemes. In PNS schemes, because all channels are sampled at the same frequency, an alias in one channel is equivalent to an alias in all channels.

In the MRS scheme of the invention, the sampling rate of each channel is chosen to be approximately equal to the maximum sampling rate allowed by cost and technology. Consequently, in most applications, the sampling rate is significantly higher than twice the maximum width of the signal bands as usually assumed in PNS schemes.

Sampling at higher rates has a fundamental advantage if signals are contaminated by noise. The spectrum evaluated at a baseband frequency f_{b} in a channel sampling at a rate F is the sum of the spectrum of the original signal at all frequencies f_{b}+mF that are located in the system bandwidth, where m ranges over all integers. Thus, the larger the value of F, the fewer the terms that contribute to this sum. As a result, sampling at a higher rate increases the signal-to-noise ratio (SNR) in the baseband region.

To simplify the hardware needed for the sampling, our reconstruction method of one embodiment was developed so as not to require synchronization between different sampling channels. Therefore, the method of the invention enables a significant reduction in the complexity of the hardware. Moreover, unsynchronized sampling relaxes the stringent requirement in PNS schemes of a very small timing jitter in the sampling time of the channels. We also do not need to solve a linear set of equations. This eliminates one source of lack of robustness of PNS schemes. Our simulations indicate that MRS schemes are robust both to different signal types and to relatively high noise. The ability of our MRS scheme to reconstruct parts of the signal spectrum that alias when sampled at all P sampling rates can be enhanced by using more complicated hardware that synchronizes all of the sampling channels.

Section 2 is organized as follows. In Section 2.2 we present some general mathematical background. In Section 2.3 we describe the algorithm. In Section 2.4 we give some considerations regarding our algorithm complexity. In Section 2.5 we present the results of computer simulations.

### 2.2 Mathematical Background and Notation

A multiband signal is one whose energy in the frequency domain is contained in a finite union of closed intervals ∪ₙ₌₁^{N}[aᵢ,bᵢ]. A multiband signal x(t) is said to be sparse in the interval [Fₘᵢₙ,Fₘₐₓ] if the Lebesgue measure of its spectral support λ(x)=Σₙ₌₁^{N}(bₙ−aₙ) satisfies λ<<Fₘₐₓ−Fₘᵢₙ.

The signals we consider are sparse multiband with spectral measure λ. We use the following form of the Fourier transform of a signal x(t):

X(f)=∫_{-∝}^{∝}x(t)exp(−2πift). (2.1)

If the signal x(t) is real (as is every physical signal), then its spectrum X satisfies X(f)= X̅(−f) where a̅+̅b̅i̅=a−bi and a and b are real numbers. Thus, a real multiband signal x(t) has the Fourier transform X(f) which, when decomposed into its support intervals, can be represented by

$$X ( f ) = {\sum }_{n = 1}^{N} [ {S}_{n} ( f ) + {\overline{S}}_{n} ( - f ) ] , \qquad ( 2.2 )$$

where Sₙ(f)≠0 only for fε[aₙ,bₙ] (where bₙ>aₙ≧0) and (aₙ,bₙ)∩ (aₘ,bₘ)=Φ for all n≈m.

We assume that F_{nyq} is known a priori. That is to say, we assume that each bₙ for a real signal is at most some We assume that F_{nyq} is known a priori. That is to say, we assume that each bₙ for a real signal is at most some known value F_{nyq}/2. Sampling a signal x(t) at a uniform rate Fⁱ produces a sampled signal

$${x}^{i} ( t ) = x ( t + {Δ}^{i} ) {\sum }_{n = - ∞}^{∞} δ ( t - \frac{n}{{F}^{i}} ) \qquad ( 2.3 )$$

where Δⁱ is a time offset between the clock of the sampling system and a hypothetical clock that defines an absolute time for the signal. Because we are assuming a lack of synchronization between more than one sampling channel, we assume that the time offsets Δⁱ are unknown. Reconstructing the amplitude of the signal spectrum with our scheme does not require knowledge of the time offsets. Only in reconstructing the phase of the signal in the frequency domain do we need in some cases to extract the differences between time offsets.

The Fourier transform of a sampled signal xⁱ(t), Xⁱ(f), is given by

$${X}^{i} ( f ) - {F}^{i} {\sum }_{n = - ∞}^{∞} X ( f + n {F}^{i} ) exp [ 2 πi ( f + n {F}^{i} ) {Δ}^{i} ] . \qquad ( 2.4 )$$

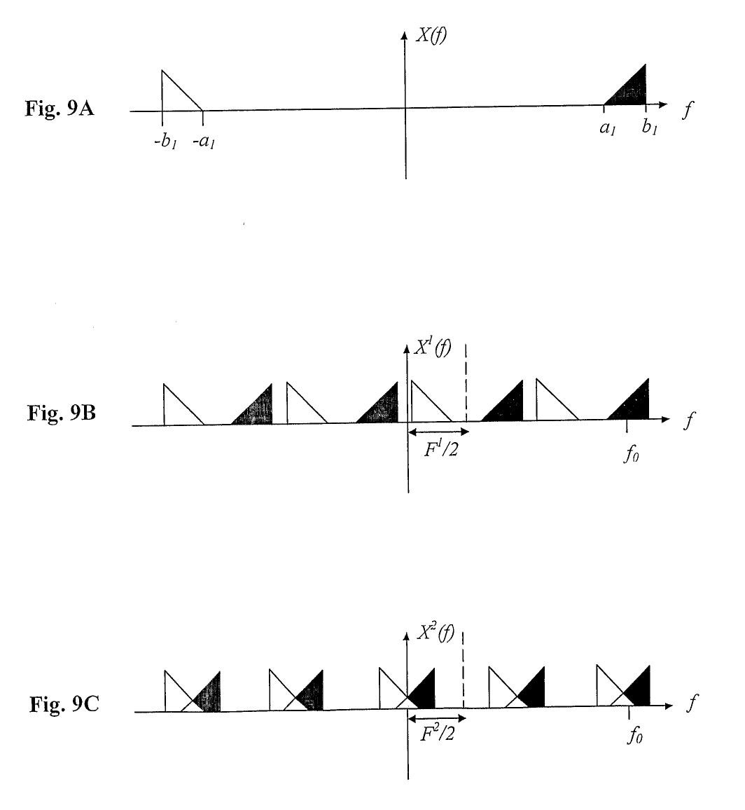

The connection between the spectrum of a sparse signal X(f) and the spectrum of its sampled signal Xⁱ(f) is illustrated in FIG. 9.

One immediate consequence of Eq. (2.4) is that, up to a phase factor that does not depend on the signal, exp[2πi(f+nFⁱ)Δⁱ], Xⁱ(f) is periodic of period Fⁱ. It is also clear that, for a real signal x(t), X̅ⁱ̅(−f)=Xⁱ(f). Thus, all of the information about |Xⁱ(f)| is contained in the interval [0,Fⁱ/2]. Besides a linear chirp caused by the time offset _i, all the information about the phase of Xⁱ (f) is also contained in the interval [0,Fⁱ/2]. We shall refer to this interval [0,Fⁱ/2] as the ith baseband. The downconversion of a frequency fε(0,F_{nyq}/2) to this baseband is represented by the downconversion function Dⁱ: [0,F_{nyq}/2]→[0,Fi/2]:

Dⁱ(f)=min[f mod Fⁱ,(Fⁱ−f)mod Fⁱ]. (2.5)

In the case of the band-limited signal X(f), for a given frequency f, all but a finite number of terms in the infinite sum on the right c-hand side of Eq. (2.4) vanish. If the number of nonvanishing terms is greater than one for a given sampling rate Fⁱ, then the signal is said to be aliased at f when sampled at the rate Fⁱ. If at a frequency f only a single term in the sum is not equal to zero, the signal X(f) is said to be unaliased at a sampling rate Fⁱ. An illustration of aliasing can be seen in FIG. 9C. In the case of sparse signals, x(t) is unaliased over a considerable part of its spectral support. The success of an MRS scheme lies in the fact that whereas a signal may be aliased at a frequency f when sampled at a rate Fⁱ, the same signal may be unaliased at the same frequency f when sampled at a different rate Fⁱ.

Each support interval [a,b] (b>a≧0) of the multiband signal will be referred to as an originating band. According to Eq. (2.4), sampling at the rate Fⁱ downconverts each originating band [a,b] to a single band in the baseband [αⁱ,βⁱ]. We shall refer to the interval [αⁱ,βⁱ] as a downconverted band.

It is apparent that when a single downconverted band [αⁱ,βⁱ] is given, it is in general not possible to identify its corresponding originating band. However, it follows easily from Eq. (2.4) that the corresponding originating band must reside within the set of bands defined by

$$\{ \begin{matrix}( {⋃}_{m = - ∞}^{∞} [ {α}^{i} + m {F}^{i} , {β}^{i} + m {F}^{i} ] ) ⋃ \\ ( {⋃}_{m = - ∞}^{∞} [ - {β}^{i} + m {F}^{i} , - {α}^{i} + m {F}^{i} ] )\end{matrix} \} ⋂ [ 0 , {F}_{nyq} / 2 ] , \qquad ( 2.6 )$$

where m is an integer. The set in Eq. (2.6) can be represented as a finite number of disjointed closed intervals, which we denote by [aₙⁱ,bₙⁱ]. We shall refer to each of these intervals as an upconverted band. For clarity, we denote all downconverted intervals with Greek letters superscripted by the sampling frequency and denote all upconverted intervals with Latin letters.

In general, the number of possible originating bands is reduced by sampling at more than one rate. For each sampling rate rate Fⁱ, an originating band [a,b] must reside within the union of the upconverted bands: [a,b]ε∪ₙ[aₙⁱ,bₙⁱ]. Since the union of upconverted bands is different for each sampling rate, sampling at several different rates gives more restrictions over the originating band [a,b]. When sampling at P rates, F¹, . . . ,F^{P}, the originating band must reside within ∩ᵢ₌₁^{P}∩ₙ[aₙⁱ,bₙⁱ].

### 2.3 Reconstruction Method

In this section we describe an algorithm to reconstruct signals from an MRS scheme. First, we describe an algorithm for reconstructing ideal multiband signals, as defined above. Then we present modifications to enable a reconstruction of signals that may be contaminated by noise outside strictly defined bands. While such signals are not exactly multiband, we still consider them multiband signals provided that the noise amplitude is considerably lower than the signal amplitude.

The reconstruction is performed sequentially. In the first step, sets of intervals in the band [0,F_{nyq}/2] that could be the support of X(f) are identified. These are sets that, when downconverted at each sampling rate Fⁱ, give energy in intervals in the baseband where significant energy is observed. For each hypothetical support, the algorithm determines the subsets of the support that are unaliased in each channel. According to Eq. (2.4), for the correct support, the amplitude of each sampled signal spectrum is proportional to the original signal spectrum over the unaliased subset of the support. As a result, for each pair of channels, the amplitudes of the two sampled signal spectra are proportional to each other over the subsets of the hypothetical support that are unaliased in both channels. Thus, we define an objective function that quantifies the consistency between the different channels over mutually unaliased subsets of the support. The algorithm chooses the hypothetical support that maximizes the objective function. The amplitude is reconstructed from the sampled data on the unaliased subsets of the chosen hypothetical support. In the last step, the phase of the spectrum of the originating signal is determined from the unaliased subset of the chosen hypothetical support.

### A. Noiseless Signals

In this subsection we assume that all signals are ideal multiband signals. Although what follows applies to more general signals, we assume that all signals have a piecewise continuous spectrum.

### 1. Reconstruction of the Spectrum Amplitude

For each sampled signal Xⁱ(f) we consider the indicator function Iⁱ (f) that indicates over which frequency intervals the energy of the sampled signal Xⁱ(f) resides. To ignore isolated points of discontinuity, we define the indicator functions Iⁱ (f) as follows:

$${ℐ}^{i} ( f ) = \{ \begin{matrix}1 & \begin{matrix}for all f ∈ [ 0 , {F}_{nyq} / 2 ] such that for all ɛ > 0 , \\ {\int }_{f - ɛ}^{f + ɛ} {\vert {X}^{i} ( {f}^{′} ) \vert}^{2} d {f}^{′} > 0\end{matrix} \\ 0 & otherwise .\end{matrix}$$

For a piecewise continuous function, it is simple to show that Iⁱ(f)=1 on closed intervals. We define the function I(f) as follows:

$$ℐ ( f ) = {\prod }_{i = 1}^{P} {ℐ}^{i} ( f ) , \\ f ∈ [ 0 , {F}_{nyq} / 2 ] . \qquad ( 2.7 )$$

Thus, the function I(f) equals (Eq. 2.1) over the intersection of all the upconverted bands of the P sampled signals. We denote the intervals over which I(f)=1 by U₁, . . . , U_{K}. Appendix A gives sufficient conditions under which each originating band coincides with one of the intervals U₁, . . . , U_{K}. Thus, it remains to determine which of the K intervals coincide with the originating intervals.

For each k=1,2, . . . , K, we consider the indicator function

$${ℐ}_{k} ( f ) = \{ \begin{matrix}1 & if f ∈ {U}_{k} \\ 0 & otherwise .\end{matrix} \qquad ( 2.8 )$$

It follows immediately from Eq. (2.8) that

$$ℐ ( f ) = {\sum }_{k = 1}^{K} {ℐ}_{k} ( f ) . \qquad ( 2.9 )$$

To find which sets of Uₖ [or Iₖ(f)] match the originating bands, each indicator function Iₖ(f) is downconverted to the baseband via the formula

$${ℐ}_{k}^{i} ( f ) = {ℐ}_{[ 0 , {F}^{i} / 2 ]} ( f ) H ( {\sum }_{n = - ∞}^{n = ∞} {ℐ}_{k} ( f + n {F}^{i} ) + {ℐ}_{k} ( - f + n {F}^{i} ) ) . \qquad ( 2.10 )$$

In Eq. (2.10) I_{[0,F}_{ⁱ}_{/2]}(f) is the indicator function of the closed interval [0,Fⁱ/2]:

$${ℐ}_{[ 0 , {F}^{i} / 2 ]} ( f ) = \{ \begin{matrix}1 & if f ∈ [ 0 , {F}^{i} / 2 ] \\ 0 & otherwise .\end{matrix} \qquad ( 2.11 )$$

Here H(f) is the Heaviside step function

$$H ( f ) = \{ \begin{matrix}0 & if f \leq 0 \\ 1 & if f > 0.\end{matrix} \qquad ( 2.12 )$$

The Heaviside step function in Eq. (2.10) is used to ensure that I^{k}ᵢ (f) is an indicator function. In the case in which the downconversions of an interval Uₖ are aliased at some frequency f within the baseband, the argument of the step function is an integer greater than 1. However, I^{k}ᵢ (f)=1. If for a frequency f in the baseband there is no signal in any of its replicas, i.e., F(nFⁱ±f)=0 for all n, then H(f)=0. As a consequence, I^{k}ᵢ(f)=0 also. Therefore, the function I^{k}ᵢ (f) is equal to one over the downconversion of the interval Uₖ corresponding to the sampling rate Fᵢ.

We consider the power set of U, P{U}, i.e., the set of all subsets of {U₁, . . . , U_{K}}. We denote an element of P{U} by U={Uₖ_{₁}, . . . , Uₖ_{_{Q}}} (0≧Q≧K). A subset UεP{U} is deemed to be a support-consistent combination if, for each sampling rate Fi, the downconversion of its intervals matches the downconverted bands of the corresponding sampled signal. In terms of indicator functions, we define for each UεP{U} the indicator functions

$${ℐ}_{𝒰}^{i} ( f ) = {\sum }_{{U}_{k} ∈ 𝒰}^{ } {ℐ}_{k}^{i} ( f ) , \\ f ∈ [ 0 , {F}^{i} / 2 ] . \qquad ( 2.13 )$$

The function Iⁱᵤ (f) is an indicator function for the downconversion of the intervals of U. Next, we define the objective function

$${E}_{1} ( 𝒰 ) = {\sum }_{i = 1}^{P} {\int }_{0}^{{F}^{i} / 2} \vert {ℐ}_{𝒰}^{i} ( f ) - {ℐ}^{i} ( f ) \vert d f . \qquad ( 2.14 )$$

The support-consistent combinations are those U for which E₁(U)=0.

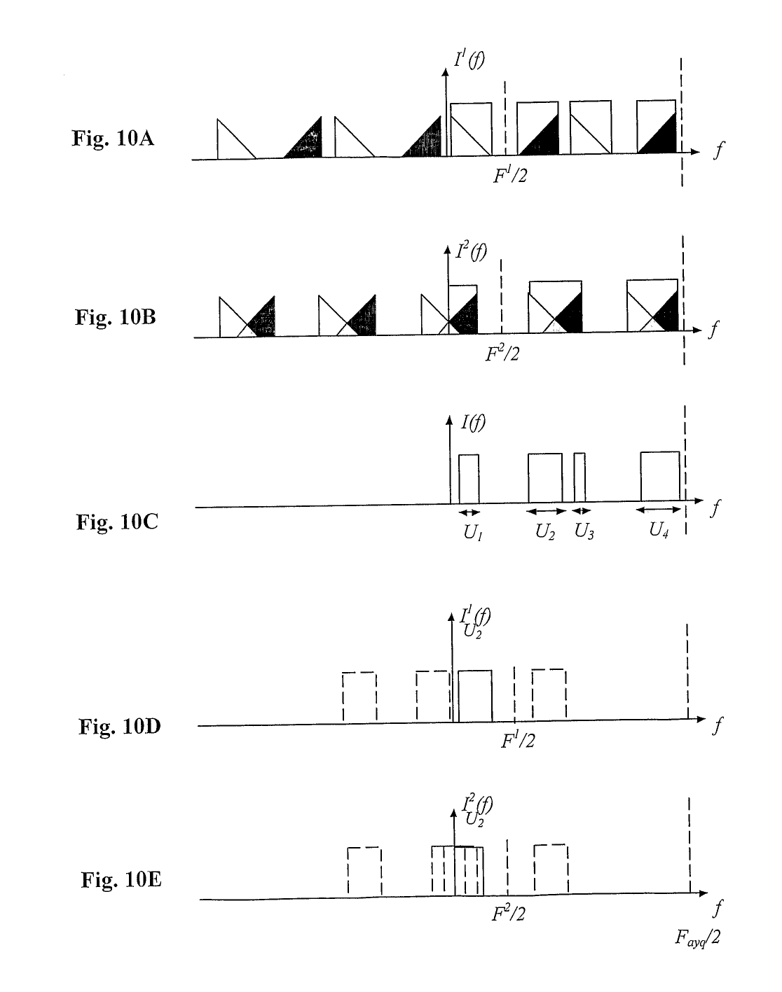

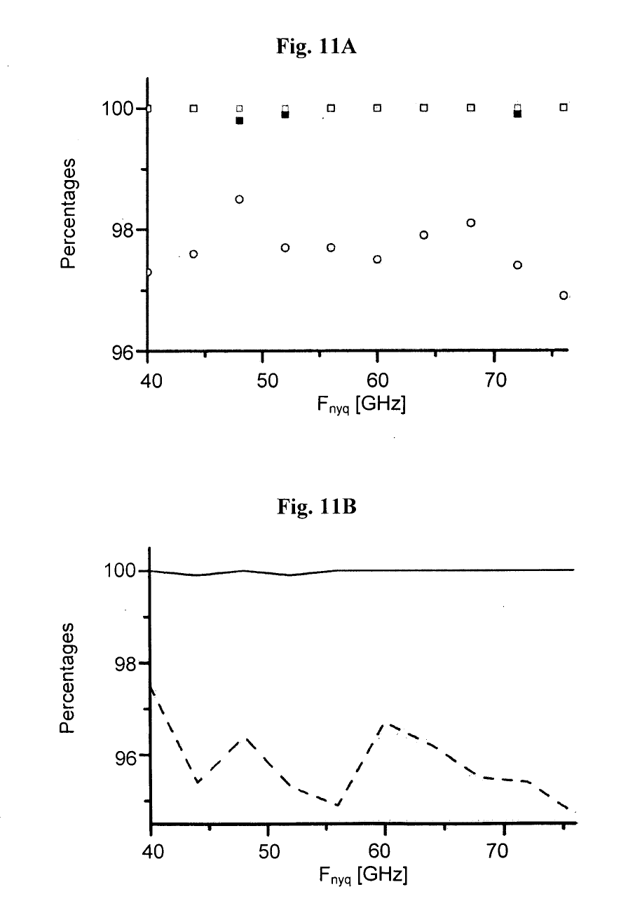

FIG. 10 illustrates the method of the invention for the signal shown in FIG. 9. The support of the signal at positive frequencies, shown in FIG. 9, consists of a single interval. FIGS. 10A and 10B are graphs of I¹(f) and I²(f), respectively. FIG. 10C is a graph of I(f). The function I(f) is equal to one over four intervals U₁, . . . , U₄. Each combination of these four intervals must be checked for support consistency. In the example illustrated in FIG. 10, we check whether the subset U={U₂}εP{U} is support consistent. FIGS. 10D and 10E show the indicator functions for the downconversion of U₂ at rates F¹ and F²: I¹_{U}_{₂}(f) and I²_{U}_{₂}(f), respectively. The dashed lines illustrate U₂, −U₂ and their downconversions. It is evident that the functions I¹(f) and I¹_{U}_{₂}(f) are not equal. Hence, U={U₂} is not a supportconsistent combination.

Among all support-consistent combinations U, it is necessary to identify the one that exactly matches the originating bands. For this purpose, we introduce two additional objective functions. The support-consistent combination U that optimizes these function is deemed to be the correct one.

Among support-consistent combinations, amplitudeconsistent combinations are defined by the amplitudes of the sampled signals at unaliased intervals. Let U={Uⱼ_{₁}, . . . , Uⱼ_{ₘ}} be a support-consistent combination. Denote the union of all intervals in U^{m}ₙ₌₁Uⱼ_{ₘ} that are unaliased when downconverted at rate Fⁱ by Σᵤⁱ⊂∪ₙ₌₁^{m}Uⱼ_{ₙ}. For the correct choice of U, at a frequency f that is unaliased when sampled at rates and Fⁱ^{₁} and Fⁱ^{₂} (fεΣᵤⁱ^{₁}∩Σᵤⁱ^{₂}), the functions |Xⁱ^{₁}(f)|/Fⁱ^{₁} and |Xⁱ^{₂}(f)|/Fⁱ^{₂} must be equal. Accordingly, we define a second objective function:

$${E}_{2} ( 𝒰 ) = {\sum }_{{i}_{1} \neq {i}_{2}}^{ } {\int }_{{\sum }_{𝒰}^{{i}_{1}} ⋂ {\sum }_{𝒰}^{{i}_{2}} }^{ } {( \vert {X}^{{i}_{1}} ( f ) \vert / {F}^{{i}_{1}} - \vert {X}^{{i}_{2}} ( f ) \vert / {F}^{{i}_{2}} )}^{2} d f . \qquad ( 2.15 )$$

For the correct U, the objective function E₂(U) must equal zero. A support-consistent combination U for which E₂(U)=0 is said to be amplitude consistent.

Unfortunately, there may be more than one amplitudeconsistent combination. This is the case, for example, when for all i₁ and i₂, Σᵤⁱ^{₁}∩Σᵤⁱ^{₂} is empty. In such cases, the objective function E₂(U) cannot be sufficient to identify the correct U. Thus, we introduce a third objective function E₃(U). This function favors options in which the integrals in Eq. (2.15) are calculated over large sets. The third objective function is defined by

$${E}_{3} ( 𝒰 ) = {\sum }_{{i}_{1} \neq {i}_{2}}^{ } λ ( {\sum }_{𝒰}^{{i}_{1}} ⋂ {\sum }_{𝒰}^{{i}_{2}} ) , \qquad ( 2.16 )$$

where λ(Σᵤⁱ^{₁}∩Σᵤⁱ^{₂}) is the Lebesgue measure of Σᵤⁱ^{₁}∩Σᵤⁱ^{₂}. The amplitude-consistent combination that maximizes E₃(U) is deemed to be the correct one. In the rare case that E₃(U) is maximized by more than one amplitudeconsistent combination, the outcome of the algorithm is not determined.

After the optimal U={Uⱼ_{₁}, . . . , Uⱼ_{ₘ}} is chosen, the amplitude of the signal is reconstructed from the samples. We define the function r(f) as the number of sampled signals that are unaliased at the frequency f:

$$r ( f ) = {\sum }_{i = 1}^{P} {I}_{{\sum }_{u}^{i}} ( f ) , where {I}_{{\sum }_{u}^{i}} ( f )$$

is the indicator function of the interval Σ_{U}ⁱ, defined similarly to Eq. (2.11). For each f within the detected originating bands, i.e., fεU^{m}ₙ₌₁Uⱼ_{ₘ}, if r(f)>0, we reconstruct the corresponding amplitude of the spectrum at f from the sampled signals by

$${X}_{𝒰} ( f ) = \frac{1}{r ( f )} {\sum }_{i = 1}^{P} \frac{\vert {X}^{i} ( f ) \vert {ℐ}_{{\sum }_{𝒰}^{i}} ( f )}{{F}^{{i}_{n}}} . \qquad ( 2.17 )$$

In words, for each frequency f that is unaliased in at least one channel, the signal amplitude is averaged over all the channels that are not aliased at f For all other frequencies, notably those that alias in all sampling channels, X_{U}(f) is set to equal zero.

### 2. Reconstruction of the Spectrum Phase

The spectrum of a signal can be expressed as X(f)=|X(f)|exp{j arg[X(f)]}. In the previous section we described how to reconstruct the amplitude |X(f)| from the signal's sampled data. In this section we describe a method of reconstructing the phase arg_|X(f)|. If the time offsets Δⁱ of Eq. (2.4), were known a priori, reconstructing the phase would be trivial. The reconstruction in this case could be performed by using a variant of Eq. (2.17) with |Xⁱ^{ₙ}(f)| replaced with Xⁱ^{ₙ}(f)exp(−2πfΔⁱ^{ₙ}). This would yield a full reconstruction of the signal (phase and amplitude). However, because of the lack of synchronization between the channels, the time offsets Δi are not known a priori. Consequently, it is more difficult to reconstruct the phase. After identifying the signal bands, we can calculate the differences Δⁱ^{₁}−Δⁱ^{₂} between two different time offsets. This is sufficient to enable the reconstruction of the phase of the signal spectrum up to a single linear phase factor.

The difference between two time offsets Δⁱ^{₁} and Δⁱ^{₂} can be calculated directly in the case that Σ_{U}ⁱ^{₁}∩Σ_{U}ⁱ^{₂} contains at least one finite interval. In this interval the phase of Xⁱ^{₁}(f)/Xⁱ^{₂}(f) satisfies the following equation:

arg[Xⁱ^{₁}(f)/X¹^{₂}(f)]=2πf(Δⁱ^{₁}−Δⁱ^{₂})+2πk, for some integer k. (2.18)

The left-hard side of Eq. (2.18) is determined by the sampled data. By performing a linear fit, we calculate the difference between the two offsets Δⁱ^{₁}/and Δⁱ^{₂}. We do this for all pairs of offsets for which Σ_{U}ⁱ^{₁}∩Σ_{U}ⁱ^{₂} contains at least one finite interval. There may exist cases in which there are i₁ and i₂ such that Σ_{U}ⁱ^{₁}∩Σ_{U}ⁱ^{₂} does not contain one finite interval but for which Δⁱ^{₁}−Δⁱ^{₂} can still be calculated. For example, in the case of three offsets Δⁱ^{₁}, Δⁱ^{₂}, and Δⁱ^{₃}, if one can calculate (Δⁱ^{₁}−Δⁱ^{₂}) and (Δⁱ^{₂}−Δⁱ^{₃}), then (Δⁱ^{₁}−Δⁱ^{₃}) can also be calculated by simple algebra. If there exist iₙ, . . . iₘ, such that for each n≦k≦m−1, Σ_{U}ⁱ^{ₖ}∩Σ_{U}ⁱ^{ₖ₊₁} contains at least one finite interval, then we say that iₙ and iₘ are phase connected and denote this by iₙ˜iₘ. If i˜j, then the difference between the two offsets Δ^{j}−Δⁱ can be calculated. In the case where Σ_{U}ⁱ does not contain any finite intervals, we define Δⁱ−Δⁱ. It is clear that ˜ is an equivalence relation [12] and thus partitions the Δⁱ into equivalence classes.

For each Δⁱ^{₁} and Δⁱ^{₂} in the same class, one can calculate their difference. One can obtain a full reconstruction of the phase if there exists one class C such that each originating frequency is unaliased in at least one channel belonging to C; i.e., there exist a class C=Δⁱ^{ₙ}, . . . , Δⁱ^{ₘ}, such that ∪ₖ₌ₙ^{m}Σ_{U}ⁱ^{ₖ}=∪ₖ₌₁^{Q}Uⱼ_{ₖ}, where U={Uⱼ_{₁}, . . . , Uⱼ_{_{Q}}}.

### B. Physical Signals

To sample realistic signals (i.e., not strictly multiband and in the presence of noise), the algorithm needs to be adjusted. In this subsection we describe adjustments to our algorithm of the invention to overcome the noise. The algorithm requires five new parameters. In Section 2.5, we give examples of reconstructing signals contaminated by strong noise. In those examples, the success of the reconstruction does not depend on the exact choice of the five parameters.

In the presence of noise, the definition of the support of the sampled signals must be adjusted. First, a small c is chosen. Then, a small positive threshold value T is chosen. The indicator function Iⁱ(f) is then redefined as follows:

$${ℐ}^{i} ( f ) = \{ \begin{matrix}1 & if f ∈ [ 0 , {F}_{nyq} / 2 ] and \frac{1}{2 ξ} {\int }_{f - ξ}^{f - ξ} \vert {X}_{α} ( {f}^{′} ) \vert d {f}^{′} > T \\ 0 & otherwise .\end{matrix} \qquad ( 2.19 )$$

The choice of the threshold T depends on the average noise level.

When reconstructing physical signals, it is not reasonable to expect E₁ (U) to equal 0 for any combination U. An initial adjustment is to require that E₁(U)<b for some positive b. The shortcoming of this condition is that the threshold b does not depend on the signal. To make the threshold depend on the signal in a simple way, we introduce the following condition:

$${E}_{1} ( 𝒰 ) < α {min}_{𝒰} [ {E}_{1} ( 𝒰 ) ] + b \qquad ( 2.20 )$$

where a≧1 is a chosen parameter. The parameters a and b control the trade-off between the chance of success and the run time. If a and b are too small, the correct subset U may not be included in the set of support-constitent combinations. On the other hand, if a and b are too large, then the number of support-consistent combinations may be large. This results in a slow run time.

Finally, we make two modifications to the objective function E₃(U). We replace the length of the mutually unaliased intervals with a weighted energy of the sampled signals in these intervals. The objective function E₃(U) is replaced with Ê₃(U):

$${\hat{E}}_{3} ( 𝒰 ) = {\sum }_{{i}_{1} \neq {i}_{2}}^{ } {\int }_{0}^{{F}_{nyq} / 2} {\vert \frac{{X}^{{i}_{1}} ( f )}{{F}^{{i}_{1}}} \vert}^{2} {W}_{{i}_{1} , {i}_{2}} ( f , 𝒰 ) d f , \qquad ( 2.21 )$$

where Wᵢ_{₁}_{,i}_{₂}(f,U) is a weight function. The weight function favors combinations in which the sampled signals are similar in mutually unaliased internals and is defined in the following.

We first note that for each of two channels i₁ and i₂, the intersection of their nonaliased supports (Σ_{U}ⁱ^{₁}∩Σ_{U}ⁱ^{₂}) is a union of a finite number of disjoint intervals Vᵢⁱ^{₁}^{,i}^{₂}, . . . V_{R}ⁱ^{₁}^{,i}^{₂}. We define

$${μ}_{{i}_{1} , {i}_{2}}^{k} ( 𝒰 ) = \frac{{\int }_{{V}_{k}^{{i}_{1} , {i}_{2}}} \vert \vert {X}^{{i}_{1}} ( f ) \vert / {F}^{{i}_{1}} - \vert {X}^{{i}_{2}} ( f ) \vert / {F}^{{i}_{2}} \vert d f}{{\int }_{{V}_{k}^{{i}_{1} , {i}_{2}}} \vert \vert {X}^{{i}_{1}} ( f ) \vert + \vert {X}^{{i}_{2}} ( f ) \vert \vert d f} . \qquad ( 2.22 )$$

Finally, we define the weight function:

$${W}_{{i}_{1} , {i}_{2}} ( f ) = {\sum }_{k}^{ } exp [ - {ρμ}_{{i}_{1} , {i}_{2}}^{k} ( 𝒰 ) ] {ℐ }_{{V}_{k}^{{i}_{1} , {i}_{2}}} ( f ) , \qquad ( 2.23 )$$

where ρ is a chosen positive constant and I Vₖⁱ^{₁}^{,i}^{₂}(f) is the indicator function of the interval Vₖⁱ^{₁}^{,i}^{₂}. The parameter ρ is chosen according to an assumed SNR. When the SNR is lower, in order to accept higher errors, ρ is chosen to be smaller. In the case of a noiseless signal and an amplitude-consistent U, each μ^{k}ᵢ_{₁}_{,i}_{₂} vanishes. Therefore, in this case, each element in the sum on the right-hand side of Eq. (2.21) gives the energy of the signal over Σ_{U}ⁱ^{₁}∩Σ_{U}ⁱ^{₂}. In all other cases, the energy in each interval Vₖⁱ^{₁}^{,i}^{₂} is weighted according to the relative error between Xⁱ^{₁}(f) and Xⁱ^{₂}(f) over Vₖⁱ^{₁}^{,i}^{₂}.

Since in the case of noisy signals neither E₁(U) nor E₂(U) vanishes for the combination that corresponds to the originating bands, both E₁(U) and E₂(U) should be considered in the final step of choosing the best combinations. Accordingly, we define the following objective function Eₜₒₜ(U):

$${E}_{tot} ( 𝒰 ) = - \frac{{E}_{1} ( 𝒰 )}{{min}_{𝒰} \{ {E}_{1} ( 𝒰 ) \}} - \frac{{E}_{2} ( 𝒰 )}{{min}_{𝒰} \{ {E}_{2} ( 𝒰 ) \}} + \frac{{\hat{E}}_{3} ( 𝒰 )}{{min}_{𝒰} \{ {\hat{E}}_{3} ( 𝒰 ) \}} \qquad ( 2.24 )$$

for all U such that min_{U}{E₁(U)}, and min_{U}{E₂(U)}, min_{U}{E₃₁(U)}≠0. Among all such combinations that also satisfy Eq. (2.20), the one that gives the maximum value of Eₜₒₜ(U) is deemed to be correct. In cases in which either min min_{U}{E₁(U)}, min min_{U}{E₂(U)}, or min_{U}{E₃(U)} equals zero for a certain combination U, the maximum of Ê₃(U) is chosen as the solution.

To reconstruct the phase, the only change made is in how the difference between the offsets is calculated. Equation (2.18) holds for all the disjoint intervals Vₖⁱ^{₁}^{,i}^{₂}εΣ_{U}ⁱ^{₁}∩Σ_{U}ⁱ^{₂}. Accordingly, we perform the linear fit for each interval and obtain a certain value for Δⁱ^{₁}−Δⁱ^{₂}. Each value is weighted by the length of its respective Vₖⁱ^{₁}^{,i}^{₂}. These weighted values are averaged. The result is an estimate for Δ¹^{₁}−Δⁱ^{₂}. This averaging procedure may increase the accuracy in the estimate of Δⁱ^{₁}−Δⁱ^{_{2.}}

### 2.4 Complexity Considerations

In this section we discuss the considerations made to reduce the computational complexity of our algorithm. Choosing a subset UεP{U} involves calculating three objective functions. We explain why eliminating possibilities through the use of E₁(U) alone can significantly reduce the run time.

In the first step of the algorithm, we find supportconsistent combinations by calculating the objective function E₁(U) for elements in P{U}. Assuming the largest element in P{U} contains K intervals, and that the signal is composed of up to N bands in [0,F_{nyq}/2], the number of elements in P{U} that one needs to check is equal to

$${\sum }_{n = 1}^{N} ( \begin{matrix}K \\ n\end{matrix} ) . \qquad ( 2.25 )$$

In the case where N≈K, the complexity is approximately O(2^{N}). When N/K [symbol] 1, the last term in Eq. (2.25), the number of options to be checked is approximately equal to O(K^{N}/N!).

The complexity of checking a single option out of P{U} for support consistency [Eq. (2.14)] is O(1), and it does not depend on the number of points used to discretize the spectrum. In contrast, the complexity of checking such an option for amplitude consistency [Eqs. (2.15) and (2.16)] is of the order of the number of points used to represent the spectrum. This is a major reason for using the supportconsistency criterion to narrow down the number of options needed to be checked for amplitude consistency. The amplitude consistency is calculated only for supportsupportconsistent options, which are in general much fewer than what is prescribed by Eq. (2.25).

### 2.5 Numerical Results

This section describes results of our numerical simulations. The simulations were carried out in the two cases considered in the previous sections: (i) ideal multiband signals and (ii) noisy signals. In all our examples, the number of channels P was set equal to three, P=3.

In all our simulations, the number of the bands in [0,F_{nyq}/2] equals N, where N≦4. Unless stated otherwise, the band number refers to the number of bands in the nonnegative frequency region [0,F_{nyq}/2]. Using the notations in Eq. (2.2), each signal in each band is given by

$${S}_{n} ( f ) = \{ \begin{matrix}{A}_{n} cos [ π ( f - {f}_{n} ) / {B}_{n} ] & if 2 \vert f - {f}_{m} \vert / {B}_{n} < 1 \\ 0 & otherwise ,\end{matrix} \qquad ( 2.26 )$$

where Bₙ is the spectral width of the nth band, fₙ, is its central frequency, and Aₙ is the maximum amplitude. The total spectral measure of the signal support equals Σₓ=2Σ^{N}ₙ₌₁Bₙ, and the minimal sampling rate is equal to 2Σₓ [8], twice the Landau rate. In each simulation, all the bands had the same width, i.e., Bₙ=Σₓ/(2N). The amplitudes Aₙ were chosen independently from a uniform distribution on [1, 1.2]. The central frequencies fₙ were also chosen independently from a uniform distribution on the region [0,F_{nyq}/2]. We eliminated cases in which there was an overlap between any two different bands. The time offsets Δⁱ were chosen independently from a uniform distribution on [0,1/Bₙ].

In each of the simulations, we set B=800 MHz and 40≦F_{nyq}≦76 GHz. This choice of parameters is consistent with previous optical sampling experiments [3]. The sampling rates were chosen as F¹=3.8F₀, F²=4F₀, and F³=4.2F₀, where the value F₀ varied between simulations. These sampling rates were chosen such that, for each pair of sampling rates (Fⁱ,F^{j}), the functions Iⁱ(f), I^{j}(f) do not have a common multiple smaller than F_{nyq}. This condition is satisfied for all F₀>F_{nyq}/76.

To obtain an exact reconstruction, the resolution in which the spectrum is represented Δf should be such that the discretization of the originating baseband downconverts exactly to the discretization grid in each baseband. This condition is satisfied when Fⁱ/Δf (i=1,2,3) is an integer. In our examples, we used a spectral resolution Δf=0.8 MHz for all the channels.

The use of the same spectral resolution for all channels is not only convenient for implementation of the algorithm of the invention, but it is also compatible with the operation of the sampling system used in our experiments [3]. In the implementation of the sampling system, an optical system performs the downconversion of the signal by multiplying it by a train of short optical pulses. In each channel a different repetition rate of the optical pulse train is used. The sampled signal in each channel is then converted into an electronic signal and passed through a lowpass filter 70 that rejects all frequencies outside the baseband. The P-filtered sampled signals have a limited bandwidth. These signals are sampled once more, this time at a constant rate, using P electronic A/D converters 90. The use of the optical system allows the use of electronic A/D converters 90 whose bandwidth is significantly lower than the bandwidth of the multiband signal [3]. Because the signals at the basebands are sampled with the same time resolution and have the same number of samples, their spectra, which are obtained using the fast Fourier transform, have the same spectral resolution.

In the first set of simulations we increased the signal bandwidth without changing the sampling rates. We used two performance criteria: correct detection of the originating bands and exact reconstruction of the signal. As to the first criterion, we required only that the spectral support of the signal be detected without an error.

As to the second criterion, we required that the signal spectrum (phase and amplitude) be fully and exactly reconstructed without any error. Because the second criterion concerns exact reconstructions, in the case that the algorithm failed to reconstruct the signal at even a single frequency, it was considered to have failed the second criterion.

We chose F₀=1 GHz. This corresponds to a total sampling rate Fₜₒₜ=F¹+F²+F³, which equals 15 times the Landau rate (7.5 the minimum possible rate). The statistics were obtained by averaging over 1000 runs. FIGS. 11A and 11B show the results for signals with three and four positive bands, respectively, as a function of the Nyquist rate. In FIG. 11A, the percentage of correct band detections is shown by the squares, whereas the full reconstruction percentage is shown by circles. The open circles and squares represent the results obtained when the maximum number of bands assumed by the algorithm was three, and the dark circles and squares represent the cases in which the maximum assumed band number was equal to four. The full reconstruction percentages were the same for both choices of the maximum number of bands, and thus the open and dark circles are indistinguishable in FIG. 11. FIG. 11B shows the band-detection percentage (solid curve) and reconstruction percentages (dashed curve) in the case where both the maximum number of originating and assumed bands is four. The figures show that both the success percentages were high and were not significantly dependent on the Nyquist rate of the signal or on the number of assumed bands.

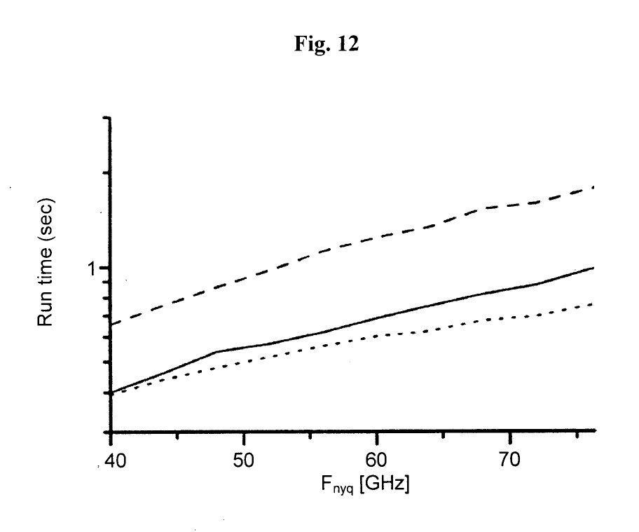

FIG. 12 shows the average run time as a function of the Nyquist rate. The results in the case of four input bands in which the assumed maximum number of bands is four is shown by the solid curve. The results in the case of three input bands is shown by the dotted curve in the case of three assumed bands and with the dashed curve in the case of four assumed bands. The results show that while an increase in the Nyquist rate does not significantly affect the reconstruction statistics, it results in an increase in the run time.

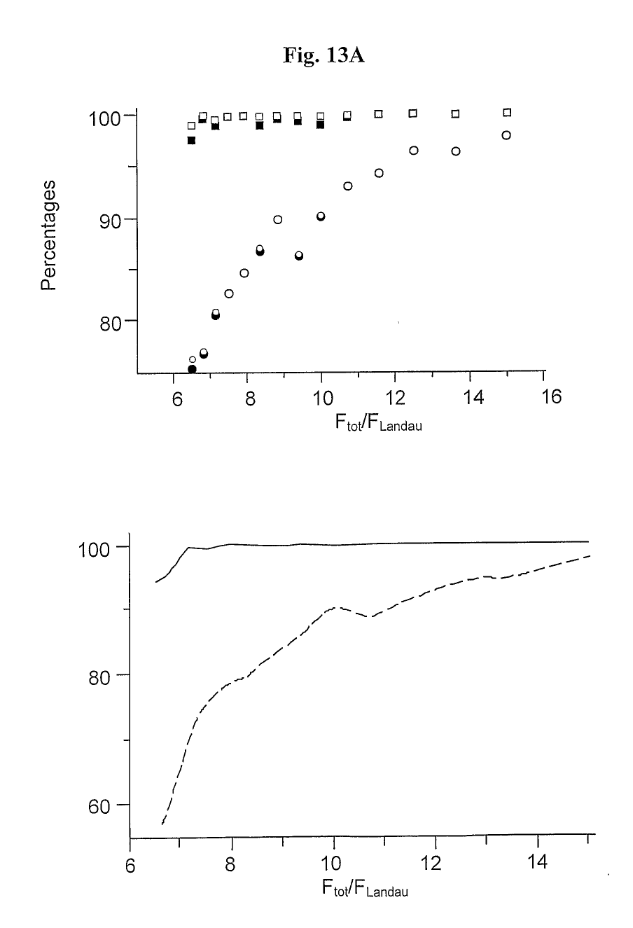

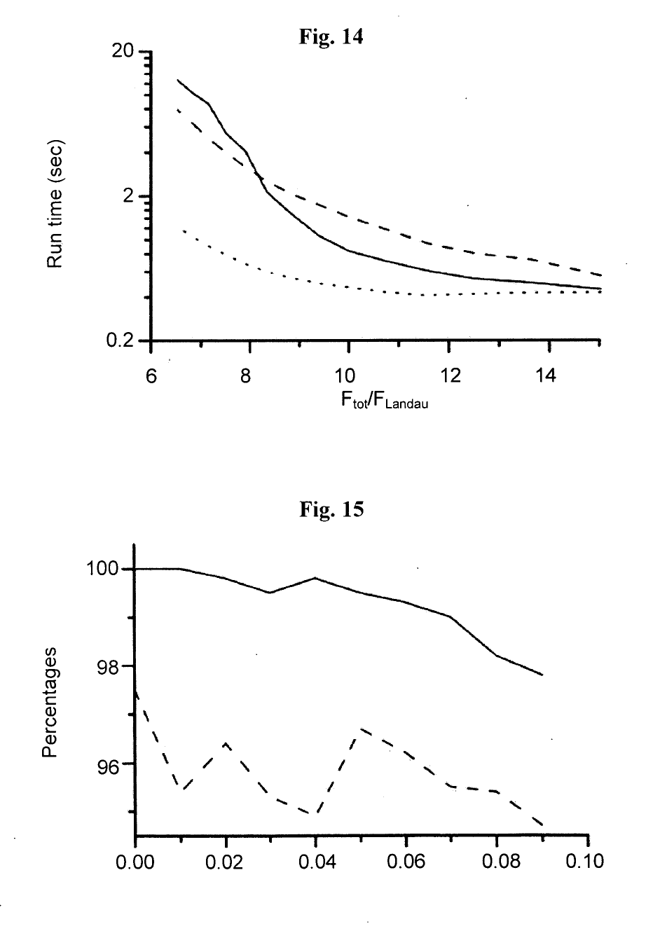

In the second set of simulations, we measured the performance of our algorithm as a function of F₀. The Nyquist rate used in the simulation was F_{nyq}=40 GHz. For each choice of F₀, the statistics were obtained by averaging over 500 runs. The results did not change significantly when the averaging was performed over 1000 runs. The simulation was run for the same number of originating bands and assumed bands as in the first set of simulations. FIGS. 13A and 13B show the success percentages for signals with three and four bands, respectively, and FIG. 14 shows the average run time. The two success percentages and the run time are shown as a function of the total sampling rate Fₜₒₜ divided by the Landau rate F_{Landau}=800 MHz. The symbols used in FIGS. 13A and 13B and FIG. 14 correspond to those used in FIGS. 11A and 11B and FIG. 12, respectively.

The results shown in FIGS. 13A and 13B demonstrate that, in all the cases that we checked, the average percentage of successful band detections was over 99.5% for sampling frequencies above 8 times the Landau rate. The reconstruction percentages were lower than these banddetection percentages and were also much more affected by the sampling rate and by the number of originating bands. As expected, the run time increases dramatically with a reduction in the sampling rate and also increases with the assumed maximum number of bands. We ran similar simulations with different numbers of originating bands and different numbers of assumed bands. The trends were similar.

In the final set of simulations, the signals are noisy. We added to the originating signal white Gaussian noise in the band [−F_{nyq}/2,F_{nyq}/2], where F_{nyq}=40 GHz. We denote by a the standard deviation of the Gaussian noise in the presampled signal. Upon sampling the signal at rate Fⁱ, the standard deviation of the noise increases to σⁱ=σ\sqrt{[F_{nyq}/Fⁱ]} owing to aliasing of the noise, where [x] equals the smallest integer greater than or equal to x.

In this set of simulations, we reconstructed signals with different noise levels added. We chose ε=6 MHz. The threshold was chosen to be T=2maxᵢ(σⁱ). Accordingly, the parameter p in Eq. (2.23) was chosen to be ρ=maxᵢ(σⁱ). The other parameters used in the simulation were a=2 and b=16 MHz. Because the signals were not ideal, an exact reconstruction was not possible and the definitions of an accurate band detection and accurate reconstruction needed to be changed. A band detection was deemed accurate if the originating bands approximately matched the reconstructed bands. A signal reconstruction was deemed accurate if the signal's originating bands were detected accurately and if each reconstructed band X_{U}(f) satisfied

$${\int }_{{B}_{m}}^{ } \vert {X}_{𝒰} ( f ) - X ( f ) \vert < {max}_{i} ( {σ}^{i} ) {B}_{m} \qquad ( 2.27 )$$

Here X(f) is the noiseless signal, and the integration is performed over only the detected band. In a correct reconstruction, it is expected that the average reconstruction error is lower than the standard deviation of the noise in the noisiest channel, i.e. the channel at the lowest sampling rate. We chose the same sampling rates as those chosen in the second set of simulations. For these rates, maxᵢ(σⁱ)=3.3σ.

The detection percentages and reconstruction percentages are shown in FIG. 15. The figure clearly shows that high percentages are obtained even in the case of a low SNR. We repeated this last set of simulations using Gaussian signals instead of the signals of Eq. (2.26). We found that the results are not sensitive to the specific choice of signal type.

### 2.6 Appendix A

In Subsection 2.3.A.1 we have denoted the intervals over which the indicator function I(f)=1 by U₁, . . . , U_{K}. In this appendix we give the sufficient and necessary conditions under which the spectral support of a signal coincides with a subset U of {U₁, . . . , U_{K}} and under which the function E₁(U) [Eq. (2.14)] is equal to zero. Although it applies for more general cases, we assume that the function X(f) is piecewise continuous.

The conditions are as follows:

1. For each frequency f₀ that fulfills ∫_{f}_{₀}_{-ε}^{f}^{₀}^{+ε}|X(f)|²df>0 for all ε>0, we obtain that ∫_{f}_{₀}_{-ε}^{f}^{₀}^{+ε}|Xⁱ(f)|²df>0 for all ε>0 and 1≦i≦P.

2. For each originating band with support [a,b], there exists an interval [a−ε,α+ε], (ε≠0), whose downconverted band does not overlap any other downconverted band in at least one of the sampled signals. Similarly, for each originating band with support [a,b], there exists an interval [b−ε,b+ε], whose downconverted band does not overlap any other downconverted band in at least one of the sampled signals.

Condition 1 ensures that originating bands are contained within U^{K}ᵢ₌₁Uᵢ. Condition 2 guarantees that the originating bands coincide exactly with a subset of P{U}. It is obvious that when the conditions are satisfied, E₁(U)=0.

The first condition excludes cases in which the downconverted bands cancel each other's energy over a certain interval due to destructive interference. When the condition is fulfilled, for each frequency f₀ within the originating bands, we obtain I(f₀)=1. Thus, each originating band [a,b] is contained within one of the intervals that make up the support of I(f). Mathematically, for each [a,b], there exist Uₖ such that [a,b]⊂Uₖ.

The second condition assures us that for each originating band [a,b], the intervals [a−ε,a] and [b,b+e] are not contained within any of the Uₖ for all values of ε. Consequentially, if [a,b]⊂Uₖ, then [a,b]=Uₖ. When the two conditions are fulfilled, we obtain that there exists a set of intervals U, which matches the originating bands, and for which E₁(U)=0

### Section 3—Multirate Synchronous Sampling of Sparse Multiband Signals

### 3.1 Introduction

In yet another embodiment of the present invention, sampling is performed in P different rates that are an integer multiple of a basic sampling rate. The sampling of all channels starts simultaneously at a given t=0. We denote this scheme as a synchronous multirate sampling (SMRS) scheme. The Fourier Transform of the undersampled signals is related to the original signal through an underdetermined system of linear equations that is described with a binary sampling matrix. It may be assumed that the samples are collected within a time window of a finite length as occurs in practical samplers when the signal bands locations are unknown. This enables us to present the signal Fourier Transform using the Discrete Fourier Transform (DFT). On the other hand, due to the finite sampling window the original signal can not be longer considered as ideally multiband. Therefore we assume that the signals are multiband in the discrete sense; i.e. their Discrete Fourier Transform has a block structure.

The sampled data in SMRS scheme can not be efficiently analyzed using standard compressive sensing approaches. The present invention thus offers a new reconstruction algorithm for blind signal reconstruction of signals sampled using SMRS scheme. The reconstruction algorithm of the invention consists of two major steps. The first step provides us with the possible signal frequencies that are consistent with the sampled data. This reduces dramatically the size of the sampling matrix and it can even give, in some cases, a full column rank matrix that can be directly inverted. If the resulting matrix is not full column rank we apply in the second step a pursuit algorithm to obtain a block-sparse solution to the underdetermined system of linear equations. We assume that among the possible solution to the reduced system of linear equations the true solution is the one that is composed from a minimum number of blocks (bands). This assumption enables us to develop an algorithm that solves the underdetermined system of linear equations with an overall very high empirical reconstruction success rate. A very high empirical reconstruction success rate was obtained in our simulations using only three sampling channels.

The ability to obtain a unique sparsest solution; i.e. a solution with the fewest non zero entries, is defined via the spark of the sampling matrix ([14] and references below). We provide sufficient condition for perfect reconstruction. Although these conditions are sufficient for perfect reconstruction, the total sampling rate required is high. However, the conditions do not take into account the block-sparsity assumption applied in our scheme. Therefore, an empirical reconstruction success rate that is close to one is obtained even when the sufficient conditions on the number of samplers and their sampling rates are not met.

The sampling pattern of SMRS scheme can also be obtained by using an equivalent multi-coset sampling scheme. However, since the time shifts between different sampling channels is very small such a scheme can not be practically implemented. Moreover, the number of channels in the equivalent multicoset sampling scheme is very high, of the order 55 in one of our practical examples. The equivalent multicoset scheme enabled us to compare the empirical reconstruction success rate of SMRS to the reconstruction methods in [8] for the practical problem studied in this manuscript. In [8] two algorithms denoted by −SBR4 and SBR2 are given for a blind reconstruction of sparse multiband signal. Since the sampling pattern in the equivalent multi-coset scheme was not a universal pattern we could not implement the algorithm described in SBR2 that enables a perfect reconstruction by using less sampling channels than required in SBR4 algorithm. We have implemented the SBR4 algorithm and compared its performance to our reconstruction method. The reconstruction method described in this manuscript gives a higher empirical reconstruction success rate than obtained by using SBR4. The higher success rate is obtained since when the sampling rate in each channel is high, the probability that a sparse signal aliases simultaneously in all sampling channels becomes very low in the SMRS scheme. It is lower than in a multi-coset sampling scheme in which, because all channels sample at the same frequency, an alias in one channel is equivalent to an alias in all channels. A universal sampling pattern that ensures a perfect reconstruction can be obtained by using a lower total sampling rate than required by SMRS scheme [6]. However, such a sampling scheme requires a significant higher number of channels than is required in the SMRS scheme. Therefore, such a sampling scheme is not practical in optical systems

In Section 2 above has experimentally demonstrated sampling and reconstruction by using sampling at three sampling channels with different sampling rates that are not synchronized in time. An accurate signal reconstruction using this asynchronous scheme requires that each frequency in the support of the signal be unaliased in at least one of the sampling channels. The SMRS scheme yields a significant increase in the reconstruction success rate by solving the aliasing using a system of linear equations. Nevertheless, errors in the sampling time between the different channels should be kept very small.

### 3.2. Synchronous Multi Rate Sampling

In this section we describe the SMRS sampling and reconstruction scheme. Let Fₘₐₓ be an assumed maximum carrier frequency and let X(f)∈L²([0, Fₘₐₓ]) be the Fourier transform of a complex-valued signal x(t) that is to be reconstructed from its samples. Throughout the analysis we calculate the Fourier transform by

X(f)=·_{-∞}^{∞}χ(t)e^{-j2πft}dt.

The modifications required to reconstruct real-valued signals are described in Appendix B. We assume that the signal x(t) to be sampled, in addition to being bandlimited in the frequency range [0, Fₘₐₓ], is multiband; i.e., the support of its Fourier Transform is contained within a finite disjoint union of intervals [aₙ, bₙ], each of which is contained in [0, Fₘₐₓ]. By assumption, max bₙ≦Fₘₐₓ.

We also assume that the signal is sparse in a frequency domain; i.e., a signal whose spectral support is contained within the N intervals (aᵢ, bᵢ], where Σₖ₌₁^{N}bₖ−aₖ<<Fₘₐₓ.

In the SMRS scheme the signal is sampled at P different sampling rates Fᵢ (i=1 . . . P). The signals modulated by an optical pulses train at ith channel xᵢ(t) are given by

$${x}_{i} ( t ) = x ( t ) {\sum }_{n = - ∞}^{∞} δ ( t - \frac{n}{{F}^{i}} ) \qquad ( 3.1 )$$

where δ(t) is a dirac delta “function”. The Fourier Transform Xᵢ(f) of the sampled signal in the ith channel satisfies

$${X}_{i} ( f ) = {F}_{i} {\sum }_{n = - ∞}^{∞} X ( f + n {F}_{i} ) . \qquad ( 3.2 )$$

It follows from (2.2) that all the information about the sampled Fourier Transform Xᵢ(f) is contained in the interval [0, Fᵢ]. This interval is called the ith baseband.

In our sampling scheme each sampling rate is an integer multiple Mᵢ of a basic frequency resolution:

Fᵢ=MᵢΔf (3.3)

We define an integer k and scalar β0≦β<Δf, so that for any 0≦f≦Fₘₐₓ, f=kΔf+β: Equation (3.2) becomes:

Xᵢ(Δfk+β)=FᵢΣ_{n=-∞}^{∞}X(kΔf+β+nMᵢΔf)==F_{iΣ}_{n=-∞}^{∞}X[(k+nMᵢ)Δf+β]. (3.4)

We define

Xᵢ^{k}(β)=Xᵢ(kΔf+β)

Xₖ(β)=X(kΔf+β). (3.5)

Using these definitions the Fourier Transform of the sampled signal at the ith channel becomes

$${X}_{i}^{k} ( β ) = {F}_{i} {\sum }_{n = - ∞}^{∞} {X}_{k + n {M}_{i}} ( β ) \qquad ( 3.6 )$$

By using the same frequency resolution Δf for all the sampling channels we are able to construct a system of linear equations that allows reconstructing the Fourier Transform of the signal. By defining M=┌Fₘₐₓ/Δf┐ to be the number of cells in the support of the original signal X (f) Eq. (3.6) becomes

$${X}_{i}^{k} ( β ) / {F}_{i} = {\sum }_{l = 0}^{M - 1} {X}_{l} ( β ) {\sum }_{n = - ∞}^{∞} δ [ l - ( k + {nM}^{ i} ) ] \qquad ( 3.7 )$$

Equation (3.7) can be written in a matrix-vector form. We define an Mᵢ×M matrix Aᵢ whose elements are given by:

$${( {A}_{i} )}_{k + 1 , l + 1} = {\sum }_{n = - ∞}^{∞} δ [ l - ( k + {nM}_{i} ) ] . \qquad ( 3.8 )$$

Each element of Aᵢ is equal to either 1 or 0. This is because there is at most one contribution in the infinite sum of δ's which is made when 1≡k (mod Mᵢ). Moreover, Aᵢ is independent of β and the signal x(β). It depends only on the sampling rates and frequency resolution.

The vectors xi (β) and x (β) are given by

(xᵢ(β))ₖᵢ=Xᵢ^{k}^{ᵢ}(β)/Fᵢ,1≦kᵢ≦Mᵢ(x(β))ₗ=Xₗ(β),1≦l≦M (3.9)

By substituting (3.8) and (3.9) to (3.7) we obtain the system of linear equation for ith channel:

xᵢ(β)=Aᵢx(β). (3.10)

For each value of i (i=1 . . . P), Eq. (3.10) defines a set of linear equations that relate the Fourier Transform of the signal to the Fourier Transform of its samples. The vector x(β) in Eq. (3.10) is the same for all the P equations because it doesn't depend on the sampling. Therefore we can construct a single system of linear equations:

\hat{x}(β)=Âx(β) (3.11)

where the vector \hat{x} (β) and the matrix Â are obtained by concatenating the vectors xᵢ (β) and matrices Aᵢ as follows:

$$\hat{x} ( β ) = ( \begin{matrix}{x}_{1} ( β ) \\ {x}_{2} ( β ) \\ ⋮ \\ {x}_{P} ( β )\end{matrix} ) , \\ \hat{A} = ( \begin{matrix}{A}_{1} \\ {A}_{2} \\ ⋮ \\ {A}_{P}\end{matrix} )$$

The matrix Â has exactly P non-vanishing elements in each column that correspond to the locations of the spectral replica in each channel baseband. We note that the matrix Â is different than used in the multi-coset sampling scheme [6].

In case that the signal is real-valued its Fourier Transform fulfills

X(f)= X̅(−f) (3.12)

where a̅+̅b̅j̅=a−bj is the complex conjugate. The equations for reconstructing such a signal are described in Appendix B.

To invert Eq. (3.11) and calculate the signal Fourier Transform x (β) it is necessary that the number of Σᵢ₌₁^{P} Mᵢ in Â be equal to or larger than the number of columns M. Defining Fₜₒₜₐₗ=Σᵢ₌₁^{P} Fᵢ makes this condition equivalent to the condition

Fₜₒₜₐₗ>Fₘₐₓ, (3.13)

The condition on the sampling rates given in Eq. (3.13) is consistent with the requirement that the sampling rate be greater than the Nyquist rate of a general signal whose spectral support is [0, Fₘₐₓ]. However, when sampling sparse signals, an inversion of the matrix may be possible even if the condition (3.13) is not fulfilled. Our objective is to invert (3.11) in the case of sparse signals with sampling rates Fₜₒₜₐₗ<Fₘₐₓ.

### 3.3 Inversion Algorithm

In this section we describe the inversion algorithm for the SMRS scheme assuming that the signal bands locations are unknown. The purpose of the algorithm is to invert (3.11); i.e., to calculate the vector x (β) from the vector \hat{x} (β).

In one embodiment of the present invention, it is assumed that the sampling time-window is finite and hence we concentrate on reconstructing the Discrete Fourier Transform (DFT) of the original signal. This requires the discretization of the continuous variable system of equations (3.11). We assume that the time window of the sampling is equal to 1/Δf and hence the DFT of each channel's sampled sequence is represented by taking β=0 in Eq. (3.10). From here on we no longer make reference to the dependence on β. The solution vector x represents the DFT of the signal sampled with the Nyquist rate within the time window of 1/Δf.

One could also increase the frequency resolution by choosing a window duration of N/Δf. This would result in a system of equations known as a Multiple Measurements Vector (MMV):

[\hat{x}(β₁) . . . \hat{χ}(β_{N})]=Â[x(β₁) . . . x(β_{N})], (3.14)

where βₙ=(n−1)Δf=N; 1≦n≦N: The solution of such system of equations can be obtained by extending the algorithm described herein.

In the case that the locations of the bands (aₙ, bₙ] are not known a priori some additional assumptions must be made.

Given sampling rates Fᵢ and the frequency resolution Δf, (3.11) is defined uniquely. Here we list the properties that a signal x must possess for our reconstruction algorithm to succeed:

Property 1. Multiband

The Discrete Fourier Transform of the signal consists of a number of bands (aₙ, bₙ] that lie inside a region [0, Fₘₐₓ] that is known a priori. Bands are defined as a sequence of nonzero amplitude values in the Discrete Fourier domain.

The maximum frequency Fₘₐₓ fulfills the requirement Fₘₐₓ<1 cm(M₁, . . . , M_{P})Δf, where 1 cm denotes least common multiple. This requirement is explained in the following subsection A. Reduction Procedure.

Property 2. Sparse

The signal is sparse; i.e, Σₙ₌₁^{N}(bₙ−aₙ)<<Fₘₐₓ. In the discrete problem the number of nonzero values in the signal DFT must be small compared to the DFT vector length.

Property 3. Existence

The original signal can be reconstructed if the signal band locations are known. Mathematically, the equations that describe the sampling of the original signal can be described by keeping only the matrix columns that correspond to signal locations:

\hat{x}_{org}=Â_{org}x_{org}, (3.15)

where x_{org} describes the Fourier Transform components that are contained in the signal x support. To be able to obtain a unique solution to (3.15) the matrix Â_{org} must have full column rank [16].

Property 4. Aliasing

We assume that a zero value in a baseband signal frequency corresponds to a zero value in all the frequencies in the original signal that are downconverted to that frequency; i.e, X^{k}₁=0 if and only if x_{k+nM}_{ᵢ}=0 for all 0≦n<M/Mᵢ. This assumption does not hold for specific signals in which two (or more) different frequency components completely cancel each other due to aliasing.

Property 5. Minimal Bands

The reduction procedure described next yields a set of signal bands that includes the bands of the sampled signals. We assume that when the problem is ill-posed (this case is treated in the next subsection), among all possible solutions, the originating signal is the one that is composed of the minimum number of bands.

A. Reduction Procedure

By observing the sampled signals one can detect baseband frequencies in which there is no signal. These baseband frequencies can be used together with Property 4—aliasing to eliminate originating frequencies and thus to reduce the matrix in Eq. (3.11).

We describe this simple procedure for eliminating frequencies which, according to our assumption, cannot be part of the spectral support of the originating signal. The elimination is similar to one presented in asynchronous-MRS in Section 2 above. We denote the indicator function Xᵢ[l] as follows:

$${χ}_{i} [ l ] = \{ \begin{matrix}1 , & for all l ∈ [ 0 , M - 1 ] such that {χ}_{i} ( l Δ f ) \neq 0 \\ 0 , & otherwise .\end{matrix} \qquad ( 3.16 )$$

The function Xᵢ(f) is periodic with period Fᵢ. Therefore Xᵢ[l] is a periodic extension of an indicator function over the baseband f∈[0, Fᵢ).

We define the X[l] as follows:

$$χ [ l ] = {\prod }_{i = 1}^{P} {χ}_{i} [ l ] , \\ l ∈ [ 0 , M - 1 ] . \qquad ( 3.17 )$$

The function X[l] equals 1 over the intersection of all the upconverted bands of the P sampled signals and it defines the columns of the matrix Â that are retained in forming the reduced matrix Â_{red}. All other columns are eliminated and their corresponding elements in the vectors x are also eliminated. After the elimination of the columns from the matrix Â, the matrix rows which correspond to zero elements in \hat{X} and their corresponding elements in the vectors \hat{X} are also eliminated. In some cases the function X[l] equals 1 only for frequencies within the spectral support of the signal. In such cases the resulting equations are identical to those found in the previous subsection (equation (3.15)). However, in other cases, X[l] may also equal 1 for frequencies outside the signal's true spectral support. In such cases the reduced matrix will have more columns than the matrix in the case in which the spectral support of the signal is known. As a result the inversion requires finding the values of more variables.

Each eliminated zero energy baseband component causes elimination of respective rows and columns. The elimination of one baseband entry means that all the frequencies that are downconverted to that baseband entry (the aliasing frequencies) are also eliminated. This is because of our fourth property—aliasing: zero entry in the baseband corresponds to zero entries in all of the frequency components of the original signal that are down-converted to frequency of the baseband entry. Therefore, elimination of one baseband entry results in elimination of └Fₘₐₓ/min{Fᵢ}┘ to ┌Fₘₐₓ/max{Fᵢ}┐ corresponding columns. Thus, if the number of the zero elements in \hat{x} is sufficiently large, the number of rows in the matrix Â_{red} may be larger than the number of columns.

If in addition, matrix Â_{red} has a full column rank, the problem is either consistent or overdetermined. In such cases there is a unique inversion to (3.15) which can be found using the Moore-Penrose pseudo-inverse. If the matrix is not full column rank, the problem is underdetermined and the inversion is not unique. A unique solution in such cases can be obtained either by increasing the total sampling rate or by adding additional assumptions on the signal.

The choice of sampling rates imposes restrictions on the possible values of Fₘₐₓ for which an inversion of (3.15) is possible. For the matrix Â_{red} to have full column rank, it must not have any identical columns. Since we do not restrict the possible locations of the known signal bands, any combination of columns of the matrix Â may appear in the matrix Â_{red}. Therefore we require that Â not have any identical columns. The matrix Â is composed of P sub-matrices Aᵢ whose columns are periodic:

(Aᵢ)_{k,l+M}_{ᵢ}=(Aᵢ)_{k,l.}

For the matrix Â not to be periodic, it is required that any common period of the P sub-matrices be larger than M. This condition is met if the least common multiple of the {Mᵢ}i is larger than M. As a result, Fₘₐₓ should fulfill Fₘₐₓ<lcm(M₁, . . . , M_{P}) Δf, where lcm denotes least common multiple.

B. Ill-Posed Cases

In many cases the matrix Â_{red} for unknown band locations is not full column rank. In these cases there are subsets of matrix columns that are linearly dependent. Using this linear dependence, a solution to (3.15) can be found. However any solution found can be used to construct an infinite number of solutions to the equation. Thus, there is no unique inverse to (3.15) and the inversion problem is ill-posed.

To reconstruct a signal in the case in which the inversion problem is ill-posed we apply Property 5—minimum bands. Under the assumptions stated earlier (the assumption that leads to matrix reduction, the existence of the unique solution to (3.15) when the signal bands are known, and band-sparsity) the inversion problem is reduced to finding the solution of (3.15) that is composed of the minimum number of bands. The problem is NP-hard since we need to test every possible combination of bands.

The algorithm described here is of lower complexity and its purpose is to find a solution of (3.15) that is composed of the minimum number of bands without testing all the combinations. The resulting algorithm attains a lower success rate but decreases the run-time significantly as compared to an NP-complex algorithm. We do not provide the conditions under which the correct solution is obtained.

The algorithm of the invention is based on the Orthogonal Matching Pursuit (OMP) [14]. This algorithm belongs to the category of the “Greedy Search” algorithms. The original OMP algorithm is used to find the sparsest solution x of underdetermined equations Ãx=b [14] where Ã is an underdetermined matrix. The sparsest solution is the solution having the smallest norm ∥x∥₀ where ∥x∥₀ is the number of non zero elements in the vector x. The original OMP algorithm collects columns of the matrix Ã iteratively to construct a reduced matrix Ãr. At each iteration n the column of Ã which is added to Ãᵣⁿ⁻¹ to produce a matrix Ãᵣⁿ is the column which results in the smallest residual error minₓ ∥b−Ãᵣⁿx∥₂² where for every vector y, ∥y∥₂²=Σᵢyᵢ². The iterations are stopped when some threshold ε is achieved. Sufficient conditions are given for the algorithm to obtain the correct solution [14].

We denote Ã=Â_{red}, b=\hat{x}_{red} and x=x_{red}. Since we are seeking the solution of Âx=b with the smallest number of bands and not the smallest norm ∥x∥₀, we modify the OMP algorithm. Instead of choosing a single column as in [14] we select iteratively blocks of columns. Each block that corresponds to sequence of ones of the function X[l] that identifies a possible band of the spectral support of the reconstructed signal. The columns of the matrix Ã can be divided into J blocks. The jth block contains the index of columns Bⱼ of the matrix Ã.

We start the iteration with the empty set S⁰=θ of column indexes, the empty matrix Ãᵣ⁰, and the set B⁰=∪ⱼ₌₁^{J}Bⱼ, so that at nth iteration the following holds: Sⁿ∪Bⁿ=B⁰. At the nth iteration (n>1) the algorithm must decide which block to add to Ãᵣⁿ⁻¹. If the index set Bⱼ is chosen, then Sⁿ=Sⁿ⁻¹∪Bj and Bⁿ=Bⁿ⁻¹\Bj. The matrix Ãᵣⁿ is the matrix whose columns are selected from Ã according to the indexing set Sⁿ.

The block added is the one that produces the smallest residual error εⁿ=min_{Bj∈B}_{^{n−1}} minₓ∥b−Ã_{r,j}ⁿx∥₂² where Ã_{r,j}ⁿ is the matrix obtained by adding the block indexed by Bⱼ to Ãᵣⁿ⁻¹. The algorithm stops when the threshold ε is reached. The threshold ε is a very small number and reflects upon the finite numerical precision of the calculations.

The algorithm performed well in our simulations. However, there were rare cases in which the support of the reconstructed solution did not contain all the originating bands and rare cases in which the reconstructed signal was incorrect even though all the assumptions on signals given in section 3.3 were fulfilled. The algorithm failed primarily for one of two reasons. One of them was due to the inclusion of a block that reduced the residual error on one hand but on the other hand, caused a resulting matrix Ãᵣⁿ to be not full column rank as hypothesized in our problem (in section 3.3). This can happen, for example, when a block consists of a correct sub-block and erroneous sub-blocks. Including any erroneous sub-blocks may result in an ill-posed problem. Another reason for failure was a large dynamic range of the signals. When reconstructing such signals, correct bands may be ignored by the algorithm in cases that the energy within the bands is significantly lower than the energy in other bands.

C. Sufficient Conditions for Perfect Reconstruction Conditions

In a multi-coset sampling scheme it is possible to obtain sufficient conditions for a perfect reconstruction [7], [8]. The proof relies on the ability to set the channels' time-offset to produce a universal sampling pattern. Assuming that there are P multi-coset sampling channels any subset of P columns of a universal sampling matrix produces a submatrix with a full column rank [6]. Specifically, for a multi-coset sampling scheme with a downsampling factor L taken to be a prime number any subset of P time shifts out of {0 . . . L−1} produces universal sampling pattern [8]. The existence of the sparsest solution of the underdetermined system of linear equations that is obtained in the multi-coset sampling scheme can be found by using the spark [8], [14] of the sampling matrix. The spark of a given matrix A is the smallest number of columns of A that are linearly dependent. For a universal sampling pattern the spark of a sampling matrix is equal to the number of the sampling channels P plus one [6]; i.e any submatrix created by selecting any set of P columns of the sampling matrix has full column rank. The sampled data obtained using SMRS scheme can be also sampled using an equivalent multi-coset scheme with a high number of sampling channels as shown in the next section. It can be easily shown that the multi-coset sampling pattern which is equivalent to the SMRS scheme will always produce a sampling pattern with a non-prime L. Therefore the universality of the sampling matrix is not guaranteed.

A lower bound on the spark of the sampling matrix Â in SMRS scheme can be obtained by calculating the mutual coherence—μ (see [14], Lemma 1). The lower bound equals μ=P in the best case when for any pair of different columns in the matrix Â the inner product equals to one at most. A sufficient condition for this case is that Fₘₐₓ<lcm(Mᵢ,Mⱼ)Δf, for each pair of channels I, j, where lcm denotes least common multiple. According to Theorem 2 of [14] a unique sparsest solution of (3.11) exists if ∥x∥₀<½(1+1/μ). This gives us a lower bound theoretical condition for perfect reconstruction of our scheme, albeit a not very satisfactory one.

To obtain a sufficient condition for perfect reconstruction we assume that the original signal is composed of N discrete bands each with a maximum width of KΔf, where K is an integer. We select the number of sampling channels P≧2N. The sampling rates of the channels are equal Fᵢ=MᵢKΔf, where the integers are chosen to satisfy Fₘₐₓ<lcm(Mᵢ,Mⱼ)KΔf for each pair of channels 1≦I, j≦P. We notice that the MMV system of linear equations (14) can be solved separately for each βₙ. Then, a unique sparsest solution x(βₙ) exists for each one of the equations. There are several methods to obtain a sparsest solution to an underdetermined system of equations, such as Orthogonal Matching Pursuit or Basis Pursuit [14]. For both methods the sufficient condition to obtain a unique sparsest solution to (3.11) is that ∥x∥₀<½(1+1/μ) (Theorems 3,4 in [14]). Therefore, the theoretical sufficient condition also guarantees that a practical algorithm converges to a right solution under the requirements we provide on the original signal and on the sampling scheme.

Although the sufficient conditions ensure a perfect reconstruction, the total sampling rate needed is higher than used in the practical applications since the required sampling rates of the channels are high. Our sufficient conditions do not take into account the reduction procedure and the assumption that the signal is composed from minimum number of bands. Therefore, an empirical reconstruction success rate that is close to one is obtained even when our sufficient conditions on the number of samplers and their sampling rates are not met, as shown in the simulations examples. Our simulation results also shows that it is preferable to use the smallest Δf as possible to obtain a minimum reconstruction error.

### 3.4 Simulations Results

The ability of the signal reconstruction algorithm to recover different types of signals was tested. In all of our simulations it was assumed that there are only three sampling channels as used in our optical system [15]. In the first set of simulations the ability of the algorithm to reconstruct multiband complex and real-valued signals with different spectral supports, shapes, and band widths that were not known a priori was tested. Additional simulations were performed in which real-valued multiband signals were contaminated by additive white noise. Band carrier frequencies were chosen from a uniform distribution over the maximum support: 0-20 GHz for complex signal and −20 to 20 GHz for real-valued signals. In different simulations the width of each band (hence the total bandwidth of the signal) was varied. The number of bands was always set equal to 4 for complex signals and to 8 for real-valued signals (4 positive bands and 4 negative frequencies bands). However, the reconstruction algorithm was unaware of this number. In all the simulations the frequency resolution was set to 5 MHz. For each set of simulations we counted the mean rate of ill-posed cases in which the modified OMP algorithm had to be used to recover the signal. Mean times for accurate signal reconstruction were also recorded. Failures of the reconstruction were either because one of the initial assumptions given in the previous section was not fulfilled or because of the failure of the modified OMP algorithm.

Since the data obtained by the SMRS scheme can be also obtained by a multi-coset sampling scheme we compared the empirical success rate of our reconstruction algorithm to the success rate obtained using SBR4 scheme of [8]. We could not implement the algorithm described in SBR2 that enables a perfect reconstruction by using less sampling channels than required in SBR4 scheme since our sampling pattern is not universal. In order to obtain a universal sampling pattern as used in SBR2 the number of sampling channels should be significantly higher than 3.

The simulations were performed on a 2 GHz Core2Duo CPU with 2 GB RAM storage in the MATLAB 7.0 (available from The MathWorks, Inc., 3 Apple Hill Drive Natick, Mass. 01760-2098 UNITED STATES) environment (no special programming was performed to use both cores).

A. Ideal Multiband Signals

Since we assume sampling in a finite length time window we represent the signals in our simulations by their DFT. Therefore, the signals we use in our simulations are sparse in a discrete sense; i.e. most of the elements of the DFT of the signal sampled at the Nyquist rate are equal to zero. On the other hand the continuous-valued Fourier Transform of the same signal does not have zero energy in any band with a finite support due to the finite time window of the signal.

For ideal signals the algorithm was evaluated by a perfect reconstruction criterion; i.e., a mean difference between the DFT of the original and the reconstructed signal is less than 10⁻¹⁰. Whenever this error was attained, the reconstruction was deemed to have been successful. Otherwise, it was deemed to have failed. The threshold for the modified OMP was chosen accordingly: ε=10⁻²⁰.

The same data that are obtained using the SMRS scheme can always be obtained by a multi-coset sampling scheme since the ratio between each pair of sampling rates is rational. However, in our examples the number of the sampling channels in the equivalent multi-coset scheme is significantly higher than in SMRS where only three sampling channels were used. In our example the sampling rate of each coset is equal to 1/LT=50 MHz. The number of multi-coset sampling channels (p) is equal to 58. The time offset between the cosets is a multiple of T=1/399 GHz. The downsampling factor L is 399 GHz/50 MHz=7980. In the first set of simulations we assumed complex signals to compare the results to those published using the multi-coset sampling recovery scheme of [8]. The sampling rates were chosen to be 0.95, 1.0 and 1.05 GHz yielding a total sampling rate Fₜₒₜₐₗ=3:0 GHz.

Different signals with 4 bands of equal width were generated. We considered a band as a sequence of consecutive samples of the signal DFT. Each band was chosen to lie within the interval of [0, 20] GHz. Both the real and imaginary spectra of the signal within each band were chosen to be normally distributed. Specifically, for each frequency f=kΔf a chosen band, the real and imaginary components of X(f) were chosen randomly and independently from a standard normal distribution.

The amplitude of each bands' spectra was scaled by a constant α such that each bands' energy was equal to a uniformly generated value E on the interval [1, 5]; i.e., for specific band,

X(f)=α[Kᵣ(f)+jXᵢₘ(f)],∥X(f)∥₂=E.

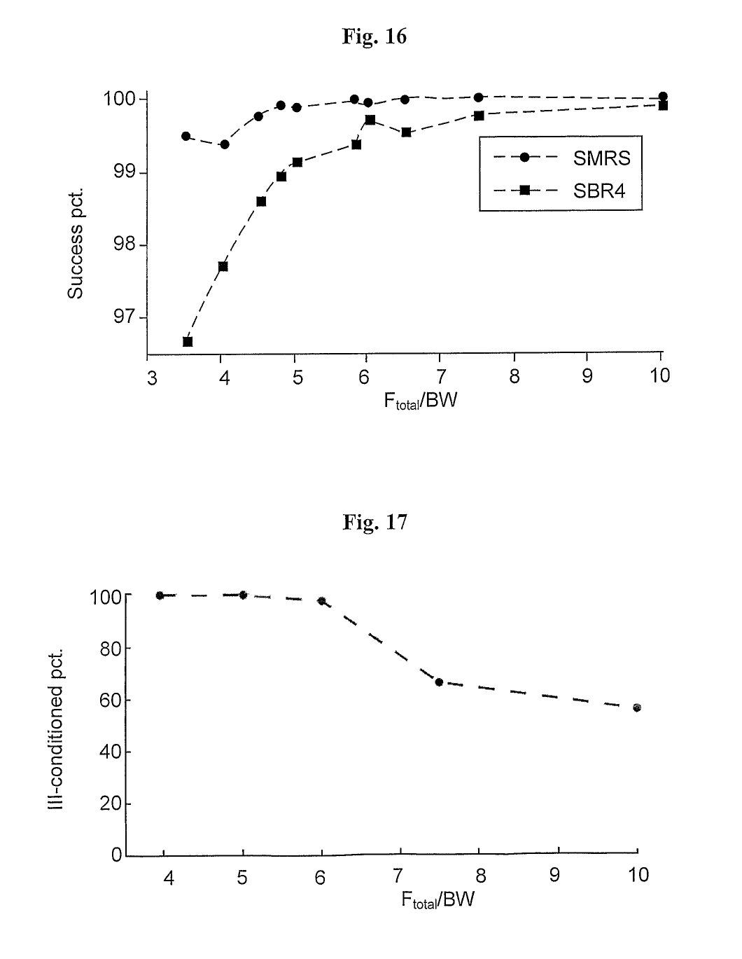

Identical DFTs of the signals were used to test the multi-coset sampling reconstruction scheme of [8]. The empirical success rates were obtained for each bandwidth (BW) of the original signal DFT by using 10,000 runs. The success rates for the two reconstruction methods is shown in FIG. 16.

As is evident from FIG. 16, the empirical success percentage of an ideal reconstruction is high using the reconstruction method of the invention when Fₜₒₜₐₗ/BW≧5. The empirical success rate is significantly higher than obtained by using SBR4 scheme of [8]. The results given in [8] shows that for L=23 the empirical perfect reconstruction is achieved with at least 6 channels and with Fₜₒₜₐₗ/BW>13. In the SMRS scheme perfect empirical success rate was obtained using only three channels with a total sampling rate that obeys Fₜₒₜₐₗ/BW, 5. The total sampling rate in a multi-coset scheme can be significantly lower than required in SMRS scheme. However, the number of channels that are used in that scheme is significantly higher compared to that used in SMRS where only 3 sampling channels are used. For example, in SBR2 scheme (downsampling factor L=199) the empirical success rate was calculated for complex signals with 4-bands each having a 100 MHz bandwidth. A perfect reconstruction was obtained for Fₜₒₜₐₗ/BW greater than about 3. However, the number of sampling channels was p=14 compared to only 3 channels in SMRS.

The mean percentage of ill-posed cases is shown in FIG. 17. The figure shows that for 4≦Fₜₒₜₐₗ/BW≦10, in most of the tested cases the matrix inversion was ill posed. Nonetheless, a very high success percentage was obtained for these cases. This indicates that our modified OMP algorithm was very successful in resolving these cases.

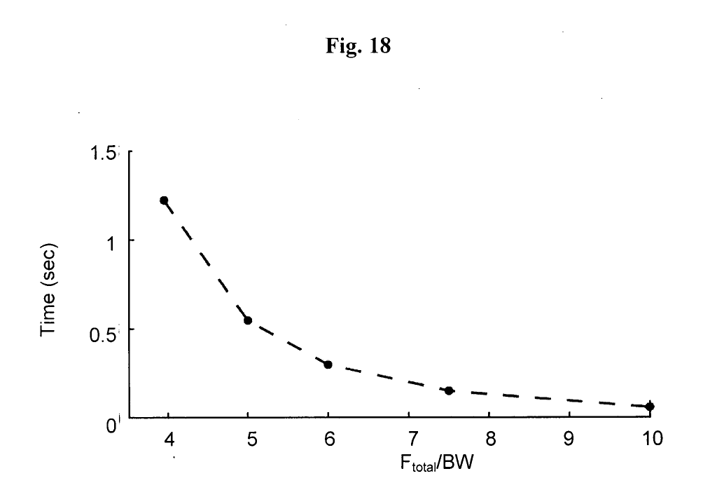

FIG. 18 shows the mean run time as a function of Fₜₒₜₐₗ/BW (constant total sampling rate and varying signal support). Because matrix inversion is the most computationally intensive operation in the algorithm, the mean run time decreases as the signal bandwidth decreases. This is because, strictly speaking, with a fixed resolution, the matrix size monotonically depends on total signal bandwidth. Moreover, as the ratio Fₜₒₜₐₗ/BW increases, the possible spectral support obtained at the first step of the reconstruction increases beyond the increase of the signal bandwidth.

The algorithm, modified as explained in Appendix B, was also tested against real-valued signals. The assumed maximum frequency Fₘₐₓ was set to 20 GHz. The number of sampling channels was set to 3 with the sampling frequencies chosen to be F₁=3.8 GHz, F₂=4.0 GHz, and F₃=4.2 GHz resulting in a total sampling rate, Fₜₒₜₐₗ=12 GHz. The sampling frequencies are the same as are used in our optical experimental setup based on asynchronous MRS described in Section 2 above. The number of bands was set to 8 (4 positive and 4 negative frequencies, assuming no carrier frequency so low as to have the 0 frequency in the signal Fourier Transform). Each band was chosen to be of equal width BW=8. Once a band (a, b] was chosen, the Fourier Transform of X(f) for f∈(a, b] was determined by the following formula:

$$X ( f ) = A sin [ \frac{π ( f - a )}{b - a} ] {e}^{j θ} .$$

The phase θ was chosen randomly from a uniform distribution on [0, 2π] and the amplitude A was chosen randomly from a uniform distribution on [1, 1.2].

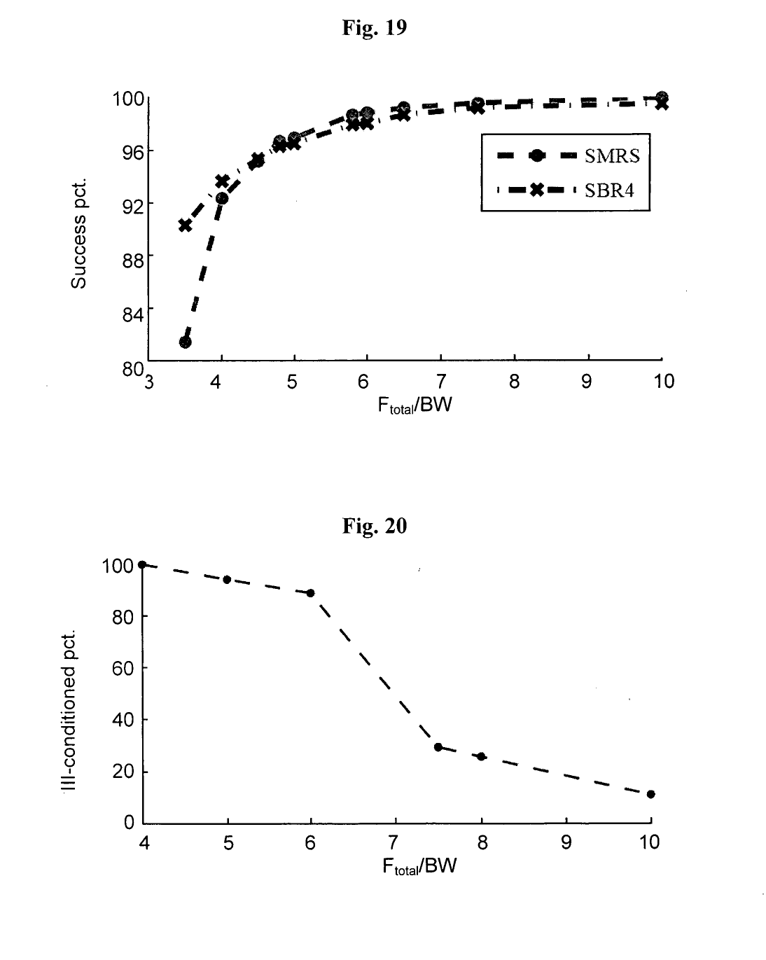

FIG. 19 shows the empirical success rate of the algorithm tested against real valued signals. As is evident from the figure, the empirical success rate is high when Fₜₒₜₐₗ/BW≧8. We note that the required sampling rate is significantly higher in this example than in the complex signals simulation. The reason is that in the real case example there are twice as many bands as in the complex case simulations. Hence, after the sampling, an overlap may also occur between the negative and the positive bands of the real signal. We note that when sampling a real signal at a sampling rate Fᵢ, it is sufficient to know the Fourier Transform in a frequency region [0, Fᵢ/2]. However, for real signals, there is uncertainty as to whether a signal in baseband is obtained from a signal in the positive band or in the negative band.

The system parameters (number of sampling channels, sampling rates, Fₘₐₓ) that were used in our last simulation are the same as those used in our optical sampling experimental setup. The fact that the simulation results were obtained in a practical situation demonstrates that our SMRS scheme can reconstruct sparse signals perfectly using both a fewer number of sampling channels and with a lower total sampling rate than are required by multi-coset sampling schemes.

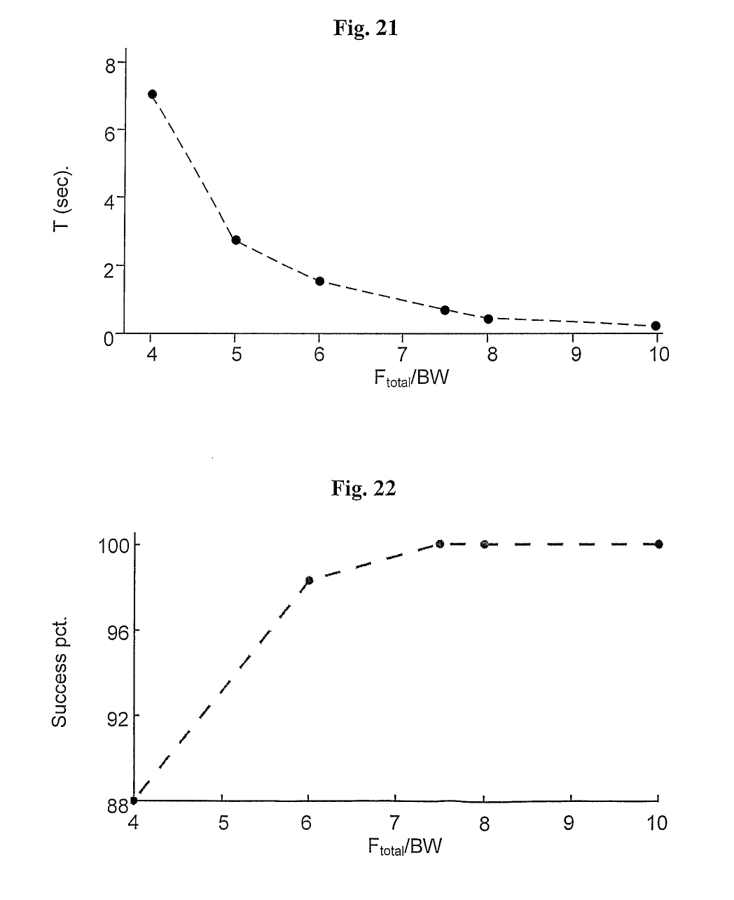

The number of ill-posed cases and the mean recovery run times for the real-valued signals are shown in FIGS. 20 and 21, respectively. It can be seen that the mean rate of ill-conditioned cases is much lower for real-valued signal simulations than for complex ones. This could be due to the correlation between positive and negative frequency components of real signals. The empirical success rate of SBR4 algorithm applied to the equivalent multicoset scheme for real-valued signals is shown in FIG. 19. It is lower than the empirical success rate of our reconstruction algorithm except for the case when the width of the bands of real-valued signals becomes very large. The SMRS requires using high frequency resolution to obtain possible signals locations. This requirement increases the run time. Specifically, for our simulation setup the run time of the SBR4 routine of [8] is smaller by a factor of about 50 than in our algorithm due to the low frequency resolution and the smaller matrices that are used.

These results show that using the constant frequency resolution to define sparsity is less effective for the SMRS scheme than for the universal multi-coset sampling scheme. The reduction procedure available in our scheme enables to define blocks adaptively according the sampled data.

### B. Noisy Signals

The algorithm's performance was also tested for its ability to reconstruct real-valued signals contaminated by Gaussian white noise. We check the case when the noise is added to the original signal. After the sampling, noise from the entire Fourier Transform is downconverted to baseband. Due to sampling at different rates the noise at baseband of each channel becomes different. Therefore, each signal component will contain a different noise after the downconversion. Since the sampling is performed at lower rate than the Nyquist rate the noise in the entire Fourier Transform can not be reconstructed and an error is introduced in the sampling.

The presence of noise demands some modification of the algorithm. One modification is in detecting the possible bands of the support of the originating signal. Because the spectral support of white noise is not restricted to the spectral support of the uncontaminated signal, the indicator functions in (3.16) cannot be used. Instead, we adapt (3.16) to noisy cases similarly as described in Section 2 above. In Section 2 above, for the indicator function Xⁱ[l] to be equal to 1 at any frequency, it was required that the average energy of the signal in the neighborhood of that frequency be higher than a certain threshold. In SMRS we further expand each band in X[l] to include additional frequencies that might otherwise be omitted when defining the indicator functions Xⁱ[l]. Once the bands are identified the matrix equations are constructed exactly as in the noiseless case.

The solution of the linear equations given in (3.25) is modified in the noisy case. Because the added white noise affects the entire Fourier Transform, a signal contaminated by white noise can no longer be considered multiband in the strict sense. Thus one cannot expect to reconstruct it perfectly from samples taken at a total rate lower than the Nyquist rate. Whereas in the ideal noiseless case the error norm vanishes, with a signal containing noise, one must relent on a perfect reconstruction and settle for a minimum error. In the noisy case the solution to (3.25) should solve the least square problem min ∥\hat{X}_{red}^{r}−Â_{red}^{r}x_{red}^{r}∥ and min ∥\hat{X}_{red}^{im}−Â_{red}^{im}x_{red}^{im}∥. When the matrices Â_{red}^{r,im} are not full column rank, we use the modified OMP algorithm which is adjusted to account for the errors due to noise. As noted above, in the noiseless case, one can expect a perfect reconstruction and thus the threshold error ε can be set to 0 or a very small number. However, with noisy signals, some care must be taken in choosing ε. On the one hand, if the ε is chosen too large, the algorithm may stop before a solution is reached. On the other hand, ifs is chosen too small, the reconstructed signal may include bands that are not in the originating signal. The problem of too high threshold is solved by adding another stop criterion. In addition of stopping the algorithm when a threshold is attained, we also check at each iteration whether the block that reduces the residual error the most causes the resulting matrix to be rank deficient. When this occurs, the iterations are stopped and the block is not added to the matrix.

An additional change is made to the algorithm when treating the blocks. In the noiseless case each block corresponds to a single band in X[l]. When sampling noisy signals, we divide each block into several sub-blocks. The reason for this division is that, with noisy signals, the identification of the bands is not accurate. Identified bands may be wider than the originating bands. This is particularly true if the chosen threshold is too small. This widening may cause the inclusion of false frequencies whose corresponding columns in Â_{red}^{r,im} are linearly dependent on the columns corresponding to the support of the originating signal. By using smaller sub-blocks such columns may be isolated from the rest of the columns in their corresponding band.

The recovery scheme was tested against real-valued signals with 8 bands (4 positive frequencies bands and 4 negative frequencies bands). The signals without noise were generated and sampled exactly as in the noiseless simulations of real signals. Noise was added randomly at each frequency of the pre-sampled signal according to a normal distribution with standard deviation σ=0:04; the SNR was defined by 10 log₁₀(1/σ\sqrt{Fₘₐₓ/F₂}))=10.5 dB, where F₂=4 GHz. This definition takes into account the accumulation of noise in baseband due to sampling. The sampling rates were the same as those in the noiseless simulations. The indicator functions Xⁱ[l] were constructed using the same parameters as those used in Section 2 above. Each band in X[l] was widened by 20 percent on each side. The sub-blocks used in the modified OMP had spectral width of 100 MHz.

The success was measured by the algorithm's ability to achieve a low error l₁ norm below 2π\sqrt{Fₘₐₓ/F₂}=4:47σ for each recovered band. The mean error for each recovered band X_{rec}(f) and the true band X(f) were evaluated as follows:

$$\frac{1}{\vert B \vert} {\int }_{B}^{ } \vert {X}_{rec} ( f ) - X ( f ) \vert d f < 2 σ \sqrt{{F}_{max} / {F}_{2}}$$

where B is the band support.

Statistics on recovering 8 bands of 200 MHz width each are based on 10,000 tests. The simulation showed that, although the algorithm's performance inevitably decreased, it still achieved a high empirical recovery rate (37 failures out of 10000 tests). Additional simulations were performed by changing the total bandwidth rates as was done in the simulations performed for the noiseless case. In FIG. 22 the empirical success percentage is presented for 1,000 simulations of noisy signals. The results of the simulations are similar to those in the noiseless case. When the total sampling rate is 8 times higher than the bandwidth rate, high success percentage was achieved. The recovery error level depended on the threshold choice. Lower threshold allows more accurate reconstruction but increases the recovery time. Different error criteria are also possible. For example, choosing l₂ norm instead of l₁ norm and setting the error threshold to be 3.3σ as in Section 2 above resulted in 99.5 percent empirical success rate in recovering signals with a total bandwidth of 1.6 GHz and 99.8 percent empirical success rate for signals with a total bandwidth of 1.5 GHz.

### 3.5 Appendix B

In this appendix we present the modifications to (3.11) for the real signals recovery. For simplicity we develop the equations for β=0. Since the signal is real-valued, its Fourier Transform fulfills

X(f)= X̅(−f) (3.18)

where a̅+̅b̅j̅=a−bj is the complex conjugate and a and b are real numbers.

It follows from (3.18) and (3.1), that for each channel index i, all the information about Xᵢ(f) is contained in the interval [0, Fᵢ/2]. Consequently, it is convenient to choose the sampling frequencies Fᵢ such that Fᵢ/2=ΔfMᵢ/2 where Mᵢ=2 is an integer. Because the conjugation operation a̅+̅j̅b̅:a+jb→a−jb is not complex linear, (3.10) needs to be replaced with two systems of equations; one for the real part and one for the imaginary part.

We use the following notations to represent the Fourier Transform of the real signals in the discretized frequencies:

Xᵢ[k]=Xᵢ(kΔf)k=−└Mᵢ/2┘, . . . ,└Mᵢ/2┘, X[k]=X(kΔf)k=−└M/2┘, . . . ,└M/2┘. (3.19)

The sequence Xᵢ[k] contains the samples of Xᵢ(f) in the baseband [−Fᵢ/2,Fᵢ/2]. The sequence X[k] contains the samples of X(f) given in [−MΔf/2,MΔf/2], where M is chosen to fulfill M=[F_{nyq}=Δf]. Equation (3.2) now takes the following form:

$${X}_{i} [ k ] = {F}_{i} {\sum }_{l = - ⌊ M / 2 ⌋}^{⌊ M / 2 ⌋} X [ l ] {\sum }_{n = - ∞}^{∞} δ [ l - ( k + {nM}_{i} ) ] . \qquad ( 3.20 )$$

Equation (3.20) can be written in a matrix form as

xᵢ=Aᵢx (3.21)

where xᵢ and x are given by

(xᵢ)_{k+└M}_{ᵢ}_{/2┘+1}=Xᵢ[k]/Fᵢ,−└Mᵢ/2┘≦k≦└Mᵢ/2┘, (x)_{k+└M/2┘+1}=X[k],−└M/2┘≦k≦└M/2┘, (3.22)

and Aᵢ is a matrix whose elements are given by

$${( {A}_{i} )}_{k} + ⌊ {M}_{i} / 2 ⌋ + 1 , l + ⌊ M / 2 ⌋ + 1 = {\sum }_{n = - ∞}^{∞} δ [ l - ( k + {nM}_{i} ) ] . \qquad ( 3.23 )$$

Note that, since the signal is real valued, all of its spectral information is contained in the positive frequencies.

Each element in Aᵢ is equal to either Fᵢ or 0. Equation (3.21) for the different sampling channels can be concatenated as in complex signals case to yield

\hat{x}=Âx. (3.24)

The Fourier Transform can be decomposed into its real and imaginary parts. As a result (3.24) becomes

\hat{x}^{r}=Â^{r}x^{r}, \hat{x}^{im}=Â^{im}x^{im} (3.25)

where \hat{X}^{r}=Re(\hat{x}) and \hat{x}^{im}=Im(\hat{x}). In addition only components that correspond to positive frequencies are retained in the vectors \hat{x}^{r} and \hat{x}^{im}. The elements of the matrices \hat{X}^{r} and \hat{x}^{im} are given by

Â_{k,└M/2┘-l+1}^{r}=Â_{k,l+1}+Â_{k,M-1}, l=0, . . . ,└M/2┘, Â_{k,└M/2┘-l+1}^{im}=Â_{k,M-l}−Â_{k,l+1}, l=0, . . . ,└M/2┘. (3.26)

The reconstruction is performed with (3.25) exactly as in the complex case.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

### REFERENCES

[1] A. E. Spezio, “Electronic Warfare Systems,” IEEE Trans. on Microwave Theory and Techniques, 50, pp. 633-644 (2002).
[2] M. I. Skolnik, Radar handbook, 2nd ed. New York: McGraw-Hill, 1990.
[3] A. Zeitouny, A. Feldser, and M. Horowitz, “Optical sampling of narrowband microwave signals using pulses generated by electroabsorption modulators,” Opt. Comm., 256, pp. 248-255 (2005).
[4] H. Landau, “Necessary density conditions for sampling and interpolation of certain entire functions,” Acta Math., 117, pp. 37-52 (1967).
[5] A. Kohlenberg, “Exact Interpolation of Band-limited Functions,” J. Appl. Phys., 24, pp. 1432-1436 (1953).
[6] R. Venkantaramani and Y. Bresler, “Optimal sub-nyquist nonuniform sampling and reconstruction for multiband signals,” IEEE Trans. Signal Process., 49, pp. 2301-2313 (2001).
[7] Y. M. Lu and M. N. Do, “A Theory for Sampling Signals from a union of Subspaces,” IEEE Trans. Signal Process., to be published.
[8] M. Mishali and Y. Eldar. “Blind multi-band signal recostruction: compressed sensing for analog signals,” arXiv:0709.1563 (September 2007).
[9] P. Feng and Y. Bresler, “Spectrum-blind minimum-rate sampling and reconstruction of multiband signals,” in Proc. IEEE Int. Conf. ASSP, Atlanta, Ga., IEEE, May 1996.
[10] Y. P. Lin and P. P. Vaidyanathan, “Periodically uniform sampling of bandpass signals,” IEEE Trans. Circuits Sys., 45, pp. 340-351 (1998).
[11] C. Herley and W. Wong, “Minimum rate sampling and reconstruction of signals with arbitrary frequency support, IEEE Trans. Inform. Theory, 45, pp. 1555-1564 (1999).
[12] I. Stewart and D. Tall, The Foundations of Mathematics (Oxford U. Press, 1977).
[13] P. W. Joudawlkis, J. J. Hargreaves, R. D. Younger, G. W. Titi, J. C. Twichell, “Optical Down-Sampling of Wide-Band Microwave Signals,” J. of Lightwave Technol., 21, pp. 3116-3124, 2004
[14] A. M. Bruckstein, D. L. Donoho and M. Elad, “From Sparse Solutions of Systems of Equations to Sparse Modeling of Signals and Images,” SIAM, to be published.
[15] A. Feldster, Y. P. Shapira, M. Horowitz, A. Rosenthal, S. Zach, and L. Singer, “Multirate asynchronous sampling of multiband signals,” to be published in IEEE J. Lightwave Technol.; arXiv:0806.2039, June 2008.
[16] R. Penrose,“A generalized inverse for matrices,” in Proc. Cambridge Philosophical Society, Cambridge, vol. 51, 1955, pp. 406-413.

1. A system for multirate sampling and reconstruction of sparse multiband signals, comprising:
(i) a plurality of optical pulse generators adapted for generating optical pulses at different rates;
(ii) an optical multiplexer adapted for adding said plurality of optical pulses;
(iii) a modulator for modulating the optical pulse trains coming out of the optical multiplexer by an electrical signal;
(iv) an optical demultiplexer adapted for separating the modulated optical pulse trains;
(v) a plurality of optical detectors adapted for detecting the separated modulated optical pulses; and
(vi) a plurality of analog-to-digital electronic converters for sampling the signal coming out of the plurality of said optical detectors.

2. A system according to claim 1, wherein each of said optical pulse generators comprises a continuous wave laser; an RF comb generator; and an electro-absorption modulator.

3. A system according to claim 1, wherein said modulator is a Mach-Zehnder modulator.

4. A system according to claim 1, wherein an optical amplifier receives the added optical pulses coming out of the optical multiplexer, amplifies the optical pulses and then outputs the amplified pulses to the modulator.

5. A system according to claim 4, wherein said optical amplifier is an erbium doped fiber amplifier.

6. A system according to claim 1, wherein the output of the optical detectors is then passed through low-pass filters.

7. A system according to claim 6, wherein the output of the low-pass filters is amplified by electrical amplifiers.

8. A system according to claim 1, comprising three optical pulse generators.

9. A system according to claim 1, wherein said plurality of optical pulse generators are synchronized in time.

10. A system according to claim 1, wherein said plurality of optical pulse generators are not synchronized in time.

11. A system according to claim 1, wherein the optical carrier frequencies of each pulsed optical source is different, and the optical multiplexer and optical de-multiplexer are of add-drop type.

12. A system for generating a train of narrow optical pulses, comprising:
(i) a constant wave laser;
(ii) an electro-absorbtion modulator; and
(iii) a radio-frequency (RF) pulse train generator, wherein the constant wave laser is modulated by RF pulses from the RF pulse train generator through the electro-absorbtion modulator.

13. A method for multirate sampling and reconstruction of sparse multiband signals, comprising the steps of:
(i) sampling the signals at n channels, each channel operating at a different frequency;
(ii) finding the supports of the signals in each channel;
(iii) up-converting the samples to all possible transmission bands according to the sampling rate in each channel;
(iv) finding all the possible up-converted support structures that are consistent with the supports of the sampled signals in each channel;
(v) finding amplitude consistent combinations;
(vi) finding large unaliased intervals of the sampled signals;
(vii) reconstructing the amplitude of the sampled signal; and
(viii) reconstructing the phase of the sampled signal.

14. A method according to claim 13, wherein n equals three.

15. A method according to claim 13, wherein the signal samples are synchronized in time.

16. A method according to claim 13, wherein the signal samples are not synchronized in time.
